(19) United States
(12) Patent Application Publication
(10) Pub. No.: US 2024/0171322 A1
(43) Pub. Date: May 23, 2024

(54) ADAPTIVE FEEDBACK METHODS FOR SUBBAND FULL DUPLEX SYSTEMS

(71) Applicant: QUALCOMM Incorporated, San Diego, CA (US)

(72) Inventors: Anantharaman BALASUBRAMANIAN, San Diego, CA (US); Shuanshuan WU, San Diego, CA (US); Kapil GULATI, Belle Mead, NJ (US); Hui GUO, Beijing (CN); Sourjya DUTTA, San Diego, CA (US); Navid ABEDINI, Basking Ridge, NJ (US); Junyi LI, Fairless Hills, PA (US)

(21) Appl. No.: 18/551,848

(22) PCT Filed: May 31, 2021
(86) PCT No.: PCT/CN2021/097146

§ 371 Date: Sep. 21, 2023

(51) Int. Cl. H04L 1/1829; H04L 5/14

(52) U.S. Cl. CPC H04L 1/1854; H04L 1/1864; H04L 5/14

(57) ABSTRACT

Methods, systems, and devices for wireless communications are described. The method includes identifying a feedback channel configuration that maps a set of multiple subchannels of a sidelink channel to a set of multiple feedback resources of a feedback channel of the sidelink channel, receiving control signaling scheduling the full duplex UE to transmit or receive a first sidelink message in a first subchannel of the set of multiple subchannels, assigning a first feedback resource of the set of multiple feedback resources for transmission or reception of feedback for the first sidelink message that differs from a default resource identified by the feedback channel configuration, and communicating feedback data for the first sidelink message in the first feedback resource of the feedback channel based on the assigning.

### CROSS REFERENCE

The present Application is a 371 national stage filing of International PCT Application No. PCT/CN2021/097146 by BALASUBRAMANIAN et al. entitled “ADAPTIVE FEEDBACK METHODS FOR SUBBAND FULL DUPLEX SYSTEMS,” filed May 31, 2021, which is assigned to the assignee hereof, and which is expressly incorporated by reference in its entirety herein.

### FIELD OF TECHNOLOGY

The following relates to wireless communications, including adaptive feedback methods for subband full duplex systems.

### BACKGROUND

Wireless communications systems are widely deployed to provide various types of communication content such as voice, video, packet data, messaging, broadcast, and so on. These systems may be capable of supporting communication with multiple users by sharing the available system resources (e.g., time, frequency, and power). Examples of such multiple-access systems include fourth generation (4G) systems such as Long Term Evolution (LTE) systems, LTE-Advanced (LTE-A) systems, or LTE-A Pro systems, and fifth generation (5G) systems which may be referred to as New Radio (NR) systems. These systems may employ technologies such as code division multiple access (CDMA), time division multiple access (TDMA), frequency division multiple access (FDMA), orthogonal FDMA (OFDMA), or discrete Fourier transform spread orthogonal frequency division multiplexing (DFT-S-OFDM). A wireless multiple-access communications system may include one or more base stations or one or more network access nodes, each simultaneously supporting communication for multiple communication devices, which may be otherwise known as user equipment (UE).

Some wireless systems may be configured to support half-duplex devices. Some wireless systems may assume that a full-duplex device is a half-duplex device. Accordingly, feedback reporting for some wireless systems may not leverage the capability of full duplex devices efficiently.

### SUMMARY

The described techniques relate to improved methods, systems, devices, and apparatuses that support adaptive feedback methods for sub-band full duplex systems. Generally, the described techniques provide for a full duplex user equipment (UE) identifying a feedback channel configuration (e.g., from a wireless network, from a base station, etc.) that maps multiple sub-channels of a sidelink channel to feedback resources of a feedback channel of the sidelink channel. The full duplex UE may receive control signaling (e.g., from another UE) that schedules the full duplex UE to transmit or receive a first sidelink message in a first sub-channel of the sub-channels. The full duplex UE may assign a first feedback resource of the feedback resources for transmission or reception of feedback for the first sidelink message that differs from a default resource indicated by the feedback channel configuration. The full duplex UE may transmit or receive feedback data for the first sidelink message in the first feedback resource of the feedback channel based on the assigning.

A method for wireless communication at a full duplex user equipment (UE) is described. The method may include identifying a feedback channel configuration that maps a set of multiple subchannels of a sidelink channel to a set of multiple feedback resources of a feedback channel of the sidelink channel, receiving control signaling scheduling the full duplex UE to transmit or receive a first sidelink message in a first subchannel of the set of multiple subchannels, assigning a first feedback resource of the set of multiple feedback resources for transmission or reception of feedback for the first sidelink message that differs from a default resource identified by the feedback channel configuration, and communicating feedback data for the first sidelink message in the first feedback resource of the feedback channel based on the assigning.

An apparatus for wireless communication at a full duplex UE is described. The apparatus may include a processor, memory coupled with the processor, and instructions stored in the memory. The instructions may be executable by the processor to cause the apparatus to identify a feedback channel configuration that maps a set of multiple subchannels of a sidelink channel to a set of multiple feedback resources of a feedback channel of the sidelink channel, receive control signaling scheduling the full duplex UE to transmit or receive a first sidelink message in a first subchannel of the set of multiple subchannels, assign a first feedback resource of the set of multiple feedback resources for transmission or reception of feedback for the first sidelink message that differs from a default resource identified by the feedback channel configuration, and communicate feedback data for the first sidelink message in the first feedback resource of the feedback channel based on the assigning.

Another apparatus for wireless communication at a full duplex UE is described. The apparatus may include means for identifying a feedback channel configuration that maps a set of multiple subchannels of a sidelink channel to a set of multiple feedback resources of a feedback channel of the sidelink channel, means for receiving control signaling scheduling the full duplex UE to transmit or receive a first sidelink message in a first subchannel of the set of multiple subchannels, means for assigning a first feedback resource of the set of multiple feedback resources for transmission or reception of feedback for the first sidelink message that differs from a default resource identified by the feedback channel configuration, and means for communicating feedback data for the first sidelink message in the first feedback resource of the feedback channel based on the assigning.

A non-transitory computer-readable medium storing code for wireless communication at a full duplex UE is described. The code may include instructions executable by a processor to identify a feedback channel configuration that maps a set of multiple subchannels of a sidelink channel to a set of multiple feedback resources of a feedback channel of the sidelink channel, receive control signaling scheduling the full duplex UE to transmit or receive a first sidelink message in a first subchannel of the set of multiple subchannels, assign a first feedback resource of the set of multiple feedback resources for transmission or reception of feedback for the first sidelink message that differs from a default resource identified by the feedback channel configuration, and communicate feedback data for the first sidelink message in the first feedback resource of the feedback channel based on the assigning.

In some examples of the method, apparatuses, and non-transitory computer-readable medium described herein, communicating the feedback data may include operations, features, means, or instructions for receiving the feedback data or transmitting the feedback data.

In some examples of the method, apparatuses, and non-transitory computer-readable medium described herein, the identifying may include operations, features, means, or instructions for receiving a control message indicating the feedback channel configuration.

Some examples of the method, apparatuses, and non-transitory computer-readable medium described herein may further include operations, features, means, or instructions for receiving, via the first subchannel, the first sidelink message and a second sidelink message in different transmission time intervals that each correspond to the first feedback resource and transmitting the feedback data for the first sidelink message in the first feedback resource based on a priority of the first sidelink message relative to a priority of the second sidelink message.

Some examples of the method, apparatuses, and non-transitory computer-readable medium described herein may further include operations, features, means, or instructions for receiving second control signaling scheduling the full duplex UE to transmit or receive a second sidelink message in a second subchannel of the set of multiple subchannels.

In some examples of the method, apparatuses, and non-transitory computer-readable medium described herein, the communicating may include operations, features, means, or instructions for communicating second feedback data for the second sidelink message on a second feedback resource of the set of multiple feedback resources based on a priority of the second sidelink message relative to a priority of the first sidelink message.

In some examples of the method, apparatuses, and non-transitory computer-readable medium described herein, the communicating may include operations, features, means, or instructions for transmitting the feedback data for the first sidelink message on a transmit feedback resource and receiving second feedback data for a second sidelink resource on a receive feedback resource having a guard band between the transmit feedback resource and the receive feedback resource, where a first location of the guard band within the set of multiple feedback resources differs from a second location of the guard band indicated in the feedback channel configuration.

Some examples of the method, apparatuses, and non-transitory computer-readable medium described herein may further include operations, features, means, or instructions for assigning each feedback resource of the set of multiple feedback resources for transmission or reception of feedback for a respective sidelink message of a set of multiple sidelink messages based on a priority of each sidelink message of the set of multiple sidelink messages.

In some examples of the method, apparatuses, and non-transitory computer-readable medium described herein, assigning the first feedback resource may include operations, features, means, or instructions for assigning the first feedback resource for transmission or reception of feedback for the first sidelink message that differs from a second feedback resource indicated in the feedback channel configuration based on a priority of the first sidelink message.

In some examples of the method, apparatuses, and non-transitory computer-readable medium described herein, assigning the first feedback resource may include operations, features, means, or instructions for assigning the first feedback resource for transmission or reception of feedback for the first sidelink message that differs from a second feedback resource indicated in the feedback channel configuration based on a priority of feedback transmission of the first sidelink message relative to a priority of feedback reception for a second sidelink message within the first feedback resource.

In some examples of the method, apparatuses, and non-transitory computer-readable medium described herein, assigning the first feedback resource may include operations, features, means, or instructions for assigning the first feedback resource for transmission or reception of feedback for the first sidelink message that differs from a second feedback resource indicated in the feedback channel configuration based on a location of a guard band assigned by the full duplex UE within the set of multiple feedback resources or indicated by the feedback channel configuration.

In some examples of the method, apparatuses, and non-transitory computer-readable medium described herein, the feedback channel configuration indicates that the first feedback resource may be a guard band.

In some examples of the method, apparatuses, and non-transitory computer-readable medium described herein, the communicating may include operations, features, means, or instructions for communicating the feedback data for the first sidelink message in the first feedback resource of the feedback channel based on using a second feedback resource of the set of multiple feedback resources as a guard band, where the feedback channel configuration indicates the second feedback resource may be a transmission feedback resource or a reception feedback resource.

In some examples of the method, apparatuses, and non-transitory computer-readable medium described herein, the assigning may include operations, features, means, or instructions for assigning the set of multiple feedback resources to increase or maximize a number of transmit feedback resources, a number of receive feedback resources, or both, in the set of multiple feedback resources for a transmission time interval relative to a number of set of multiple feedback resources assigned to be a guard band.

In some examples of the method, apparatuses, and non-transitory computer-readable medium described herein, the assigning may include operations, features, means, or instructions for assigning the set of multiple feedback resources to increase or maximize a number of transmit feedback resources in the set of multiple feedback resources for a transmission time interval, where a number of feedback resources assigned to be a receive feedback resource in the set of multiple feedback resources satisfies a threshold.

In some examples of the method, apparatuses, and non-transitory computer-readable medium described herein, the assigning may include operations, features, means, or instructions for assigning the set of multiple feedback resources to increase or maximize a number of receive feedback resources in the set of multiple feedback resources for a transmission time interval, where a number of feedback resources assigned to be a transmit feedback resource in the set of multiple feedback resources satisfies a threshold.

In some examples of the method, apparatuses, and non-transitory computer-readable medium described herein, the assigning may include operations, features, means, or instructions for determining that an initial assignment of the set of multiple feedback resources does not satisfy one or more constraints and switching a transmit feedback resource in the initial assignment to be a receive feedback resource, or switching a receive feedback resource the initial assignment to be a transmit feedback resource based on the determining, or both.

In some examples of the method, apparatuses, and non-transitory computer-readable medium described herein, the assigning may include operations, features, means, or instructions for determining that an initial assignment of the set of multiple feedback resources does not satisfy one or more constraints and changing a second feedback resource in the initial assignment to be a guard band between a transmit feedback resource and a receive feedback resource.

### BRIEF DESCRIPTION OF THE DRAWINGS

FIG. 1 illustrates an example of a wireless communications system that supports adaptive feedback methods for subband full duplex systems in accordance with aspects of the present disclosure.

FIG. 2 illustrates an example of a wireless communication system in accordance with aspects of the present disclosure.

FIG. 3 illustrates an example of a configuration of a sidelink channel in accordance with aspects of the present disclosure.

FIG. 4 illustrates an example of a configuration of a sidelink channel in accordance with aspects of the present disclosure.

FIG. 5 illustrates an example of a configuration of a sidelink channel in accordance with aspects of the present disclosure.

FIG. 6 illustrates an example of a configuration of a sidelink channel in accordance with aspects of the present disclosure.

FIG. 7 illustrates an example of a configuration of a sidelink channel in accordance with aspects of the present disclosure.

FIGS. 8 and 9 show block diagrams of devices in accordance with aspects of the present disclosure.

FIG. 10 shows a block diagram of a communications manager in accordance with aspects of the present disclosure.

FIG. 11 shows a diagram of a system including a device in accordance with aspects of the present disclosure.

FIGS. 12 and 13 show flowcharts illustrating methods that support adaptive feedback methods for subband full duplex systems in accordance with aspects of the present disclosure.

### DETAILED DESCRIPTION

The present techniques include adaptive feedback methods for sub-band full duplex systems. Vehicle-to-everything (V2X) is a communication protocol for communications between a vehicle and any entity that may affect, or may be affected by, the vehicle. V2X may include device-to-network (e.g., vehicle-to-network (V2N)) communication between a device and a network, and device-to-device (e.g., vehicle-to-vehicle (V2V), sidelink communications), etc. Some V2X systems may implement a half-duplex communication system. In a half-duplex V2X systems, there is a mapping between the resources where the user equipment (UE) transmits (e.g., sub-channels) and the resources in which the UE expects to receive a feedback (e.g., hybrid automatic repeat request (HARQ) feedback). Hence, a receiver UE transmits its feedback (e.g., via physical sidelink feedback channel) on a resource based on the sub-channel on which the receiver UE receives data (e.g., physical sidelink shared channel) and the transmit ID of the transmit UE that the receiver UE infers from sidelink control information (SCI).

In some cases, a half-duplex V2X system may decrease spectral efficiency and data throughput for V2X devices to the detriment of user experience based on the increased system latencies of half-duplex communications and relatively low quality of service as compared to systems that support full duplex communications. Even when full duplex devices are used, feedback reporting for V2X systems is based on the assumption that all UEs, including full duplex UEs, are half-duplex UEs. Accordingly, feedback reporting for some V2X systems may not assign feedback resources that leverage the capability of full duplex UEs efficiently.

The present techniques enable full duplex for UEs in V2X systems to dynamically and efficiently assign respective feedback resources of a sidelink feedback channel for transmission or reception of feedback that leverages full duplex capabilities of V2X devices to enhance or maximize the number of feedback transmissions and receptions sent within the sidelink feedback channel of a particular transmission time interval. A full duplex UE may be configured with a set of feedback resources on which feedback is to be communicated, where each of the feedback resources corresponds to a respective sub-channel of a sidelink channel.

The present techniques enable a full duplex UE to adaptively determine the feedback resources on which to transmit or receive feedback that may differ from a default configuration, resulting in the associated system increasing the efficiency and the amount of hybrid automatic repeat request (HARQ) feedback transmissions/receptions. In some examples, a UE may dynamically select the number of feedback resources to be used for transmitting feedback data (e.g., HARQ data) and for receiving feedback data corresponding to sidelink messages communicated via the sidelink channel.

To prevent signal leakage between the feedback resources, the UE may adaptively determine which of the feedback resources to use for one or more guard bands that may differ from resources configured as guard band resources. The decision of a UE to use a resource for feedback transmission or feedback reception may depend on the priority (e.g., absolute priority) of two or more sidelink messages for which feedback is to be transmitted or received that are competing for the same feedback resources, or the ability of the UE to perform transmission and reception of feedback concurrently, or whether feedback transmission or feedback reception is to be prioritized on a feedback resource, or any combination thereof.

Aspects of the subject matter described herein may be implemented to realize one or more advantages. The described techniques may support improvements in system efficiency and quality of service. The described techniques may result in avoiding multiple retransmissions and failed transmissions, decreasing system latency, improving the reliability of feedback procedures for sub-band full duplex systems, and improving user experience.

Aspects of the disclosure are initially described in the context of wireless communications systems. Aspects of the disclosure are further illustrated by and described with reference to configurations of a sidelink channel that relate to adaptive feedback methods for sub-band full duplex systems. Aspects of the disclosure are further illustrated by and described with reference to apparatus diagrams, system diagrams, and flowcharts that relate to adaptive feedback methods for sub-band full duplex systems.

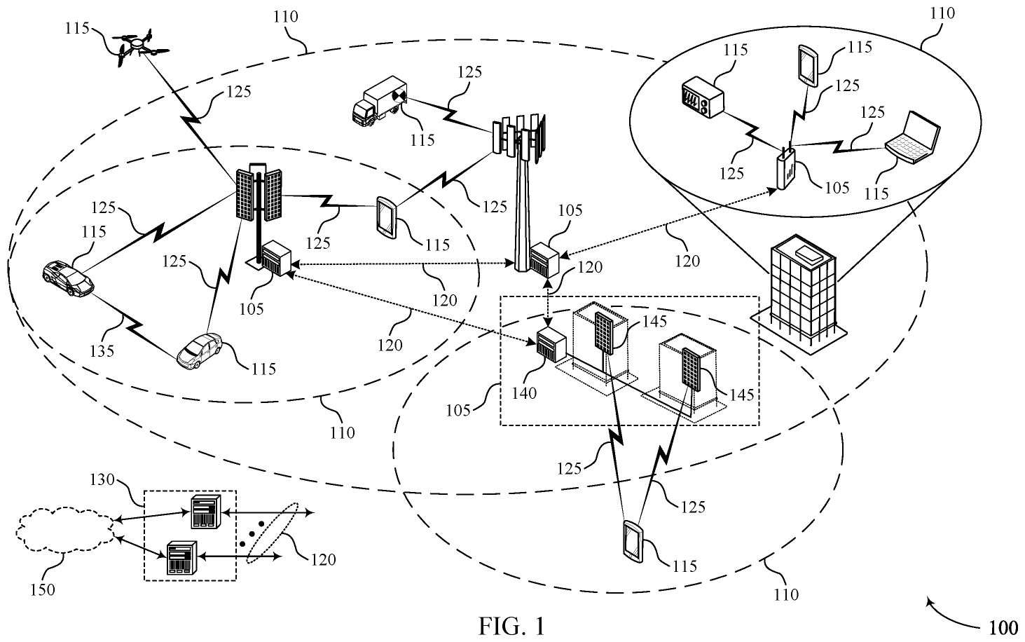

FIG. 1 illustrates an example of a wireless communications system 100 that supports adaptive feedback methods for subband full duplex systems in accordance with aspects of the present disclosure. The wireless communications system 100 may include one or more base stations 105, one or more UEs 115, and a core network 130. In some examples, the wireless communications system 100 may be a Long Term Evolution (LTE) network, an LTE-Advanced (LTE-A) network, an LTE-A Pro network, or a New Radio (NR) network. In some examples, the wireless communications system 100 may support enhanced broadband communications, ultra-reliable (e.g., mission critical) communications, low latency communications, communications with low-cost and low-complexity devices, or any combination thereof.

The base stations 105 may be dispersed throughout a geographic area to form the wireless communications system 100 and may be devices in different forms or having different capabilities. The base stations 105 and the UEs 115 may wirelessly communicate via one or more communication links 125. Each base station 105 may provide a coverage area 110 over which the UEs 115 and the base station 105 may establish one or more communication links 125. The coverage area 110 may be an example of a geographic area over which a base station 105 and a UE 115 may support the communication of signals according to one or more radio access technologies.

The UEs 115 may be dispersed throughout a coverage area 110 of the wireless communications system 100, and each UE 115 may be stationary, or mobile, or both at different times. The UEs 115 may be devices in different forms or having different capabilities. Some example UEs 115 are illustrated in FIG. 1. The UEs 115 described herein may be able to communicate with various types of devices, such as other UEs 115, the base stations 105, or network equipment (e.g., core network nodes, relay devices, integrated access and backhaul (IAB) nodes, or other network equipment), as shown in FIG. 1.

The base stations 105 may communicate with the core network 130, or with one another, or both. For example, the base stations 105 may interface with the core network 130 through one or more backhaul links 120 (e.g., via an S1, N2, N3, or other interface). The base stations 105 may communicate with one another over the backhaul links 120 (e.g., via an X2, Xn, or other interface) either directly (e.g., directly between base stations 105), or indirectly (e.g., via core network 130), or both. In some examples, the backhaul links 120 may be or include one or more wireless links.

One or more of the base stations 105 described herein may include or may be referred to by a person having ordinary skill in the art as a base transceiver station, a radio base station, an access point, a radio transceiver, a NodeB, an eNodeB (eNB), a next-generation NodeB or a giga-NodeB (either of which may be referred to as a gNB), a Home NodeB, a Home eNodeB, or other suitable terminology.

A UE 115 may include or may be referred to as a mobile device, a wireless device, a remote device, a handheld device, or a subscriber device, or some other suitable terminology, where the “device” may also be referred to as a unit, a station, a terminal, or a client, among other examples. A UE 115 may also include or may be referred to as a personal electronic device such as a cellular phone, a personal digital assistant (PDA), a tablet computer, a laptop computer, or a personal computer. In some examples, a UE 115 may include or be referred to as a wireless local loop (WLL) station, an Internet of Things (IoT) device, an Internet of Everything (IoE) device, or a machine type communications (MTC) device, among other examples, which may be implemented in various objects such as appliances, or vehicles, meters, among other examples.

The UEs 115 described herein may be able to communicate with various types of devices, such as other UEs 115 that may sometimes act as relays as well as the base stations 105 and the network equipment including macro eNBs or gNBs, small cell eNBs or gNBs, or relay base stations, among other examples, as shown in FIG. 1.

The UEs 115 and the base stations 105 may wirelessly communicate with one another via one or more communication links 125 over one or more carriers. The term “carrier” may refer to a set of radio frequency spectrum resources having a defined physical layer structure for supporting the communication links 125. For example, a carrier used for a communication link 125 may include a portion of a radio frequency spectrum band (e.g., a bandwidth part (BWP)) that is operated according to one or more physical layer channels for a given radio access technology (e.g., LTE, LTE-A, LTE-A Pro, NR). Each physical layer channel may carry acquisition signaling (e.g., synchronization signals, system information), control signaling that coordinates operation for the carrier, user data, or other signaling. The wireless communications system 100 may support communication with a UE 115 using carrier aggregation or multi-carrier operation. A UE 115 may be configured with multiple downlink component carriers and one or more uplink component carriers according to a carrier aggregation configuration. Carrier aggregation may be used with both frequency division duplexing (FDD) and time division duplexing (TDD) component carriers.

Signal waveforms transmitted over a carrier may be made up of multiple subcarriers (e.g., using multi-carrier modulation (MCM) techniques such as orthogonal frequency division multiplexing (OFDM) or discrete Fourier transform spread OFDM (DFT-S-OFDM)). In a system employing MCM techniques, a resource element may consist of one symbol period (e.g., a duration of one modulation symbol) and one subcarrier, where the symbol period and subcarrier spacing are inversely related. The number of bits carried by each resource element may depend on the modulation scheme (e.g., the order of the modulation scheme, the coding rate of the modulation scheme, or both). Thus, the more resource elements that a UE 115 receives and the higher the order of the modulation scheme, the higher the data rate may be for the UE 115. A wireless communications resource may refer to a combination of a radio frequency spectrum resource, a time resource, and a spatial resource (e.g., spatial layers or beams), and the use of multiple spatial layers may further increase the data rate or data integrity for communications with a UE 115.

The time intervals for the base stations 105 or the UEs 115 may be expressed in multiples of a basic time unit which may, for example, refer to a sampling period of Tₛ=1/(Δfₘₐₓ·N_{f}) seconds, where Δfₘₐₓ may represent the maximum supported subcarrier spacing, and N_{f} may represent the maximum supported discrete Fourier transform (DFT) size. Time intervals of a communications resource may be organized according to radio frames each having a specified duration (e.g., 10 milliseconds (ms)). Each radio frame may be identified by a system frame number (SFN) (e.g., ranging from 0 to 1023).

Each frame may include multiple consecutively numbered subframes or slots, and each subframe or slot may have the same duration. In some examples, a frame may be divided (e.g., in the time domain) into subframes, and each subframe may be further divided into a number of slots. Alternatively, each frame may include a variable number of slots, and the number of slots may depend on subcarrier spacing. Each slot may include a number of symbol periods (e.g., depending on the length of the cyclic prefix prepended to each symbol period). In some wireless communications systems 100, a slot may further be divided into multiple mini-slots containing one or more symbols. Excluding the cyclic prefix, each symbol period may contain one or more (e.g., N_{f}) sampling periods. The duration of a symbol period may depend on the subcarrier spacing or frequency band of operation.

A subframe, a slot, a mini-slot, or a symbol may be the smallest scheduling unit (e.g., in the time domain) of the wireless communications system 100 and may be referred to as a transmission time interval (TTI). In some examples, the TTI duration (e.g., the number of symbol periods in a TTI) may be variable. Additionally or alternatively, the smallest scheduling unit of the wireless communications system 100 may be dynamically selected (e.g., in bursts of shortened TTIs (sTTIs)).

Physical channels may be multiplexed on a carrier according to various techniques. A physical control channel and a physical data channel may be multiplexed on a downlink carrier, for example, using one or more of time division multiplexing (TDM) techniques, frequency division multiplexing (FDM) techniques, or hybrid TDM-FDM techniques. A control region (e.g., a control resource set (CORESET)) for a physical control channel may be defined by a number of symbol periods and may extend across the system bandwidth or a subset of the system bandwidth of the carrier. One or more control regions (e.g., CORESETs) may be configured for a set of the UEs 115. For example, one or more of the UEs 115 may monitor or search control regions for control information according to one or more search space sets, and each search space set may include one or multiple control channel candidates in one or more aggregation levels arranged in a cascaded manner. An aggregation level for a control channel candidate may refer to a number of control channel resources (e.g., control channel elements (CCEs)) associated with encoded information for a control information format having a given payload size. Search space sets may include common search space sets configured for sending control information to multiple UEs 115 and UE-specific search space sets for sending control information to a specific UE 115.

In some examples, a base station 105 may be movable and therefore provide communication coverage for a moving geographic coverage area 110. In some examples, different geographic coverage areas 110 associated with different technologies may overlap, but the different geographic coverage areas 110 may be supported by the same base station 105. In other examples, the overlapping geographic coverage areas 110 associated with different technologies may be supported by different base stations 105. The wireless communications system 100 may include, for example, a heterogeneous network in which different types of the base stations 105 provide coverage for various geographic coverage areas 110 using the same or different radio access technologies.

The wireless communications system 100 may be configured to support ultra-reliable communications or low-latency communications, or various combinations thereof. For example, the wireless communications system 100 may be configured to support ultra-reliable low-latency communications (URLLC) or mission critical communications. The UEs 115 may be designed to support ultra-reliable, low-latency, or critical functions (e.g., mission critical functions). Ultra-reliable communications may include private communication or group communication and may be supported by one or more mission critical services such as mission critical push-to-talk (MCPTT), mission critical video (MCVideo), or mission critical data (MCData). Support for mission critical functions may include prioritization of services, and mission critical services may be used for public safety or general commercial applications. The terms ultra-reliable, low-latency, mission critical, and ultra-reliable low-latency may be used interchangeably herein.

In some examples, a UE 115 may also be able to communicate directly with other UEs 115 over a device-to-device (D2D) communication link 135 (e.g., using a peer-to-peer (P2P) or D2D protocol). One or more UEs 115 utilizing D2D communications may be within the geographic coverage area 110 of a base station 105. Other UEs 115 in such a group may be outside the geographic coverage area 110 of a base station 105 or be otherwise unable to receive transmissions from a base station 105. In some examples, groups of the UEs 115 communicating via D2D communications may utilize a one-to-many (1:M) system in which each UE 115 transmits to every other UE 115 in the group. In some examples, a base station 105 facilitates the scheduling of resources for D2D communications. In other cases, D2D communications are carried out between the UEs 115 without the involvement of a base station 105.

In some systems, the D2D communication link 135 may be an example of a communication channel, such as a sidelink communication channel, between vehicles (e.g., UEs 115). In some examples, vehicles may communicate using vehicle-to-everything (V2X) communications, vehicle-to-vehicle (V2V) communications, or some combination of these. A vehicle may signal information related to traffic conditions, signal scheduling, weather, safety, emergencies, or any other information relevant to a V2X system. In some examples, vehicles in a V2X system may communicate with roadside infrastructure, such as roadside units, or with the network via one or more network nodes (e.g., base stations 105) using vehicle-to-network (V2N) communications, or with both.

The core network 130 may provide user authentication, access authorization, tracking, Internet Protocol (IP) connectivity, and other access, routing, or mobility functions. The core network 130 may be an evolved packet core (EPC) or 5G core (5GC), which may include at least one control plane entity that manages access and mobility (e.g., a mobility management entity (MME), an access and mobility management function (AMF)) and at least one user plane entity that routes packets or interconnects to external networks (e.g., a serving gateway (S-GW), a Packet Data Network (PDN) gateway (P-GW), or a user plane function (UPF)). The control plane entity may manage non-access stratum (NAS) functions such as mobility, authentication, and bearer management for the UEs 115 served by the base stations 105 associated with the core network 130. User IP packets may be transferred through the user plane entity, which may provide IP address allocation as well as other functions. The user plane entity may be connected to IP services 150 for one or more network operators. The IP services 150 may include access to the Internet, Intranet(s), an IP Multimedia Subsystem (IMS), or a Packet-Switched Streaming Service.

Some of the network devices, such as a base station 105, may include subcomponents such as an access network entity 140, which may be an example of an access node controller (ANC). Each access network entity 140 may communicate with the UEs 115 through one or more other access network transmission entities 145, which may be referred to as radio heads, smart radio heads, or transmission/reception points (TRPs). Each access network transmission entity 145 may include one or more antenna panels. In some configurations, various functions of each access network entity 140 or base station 105 may be distributed across various network devices (e.g., radio heads and ANCs) or consolidated into a single network device (e.g., a base station 105).

The wireless communications system 100 may operate using one or more frequency bands, typically in the range of 300 megahertz (MHz) to 300 gigahertz (GHz). Generally, the region from 300 MHz to 3 GHz is known as the ultra-high frequency (UHF) region or decimeter band because the wavelengths range from approximately one decimeter to one meter in length. The UHF waves may be blocked or redirected by buildings and environmental features, but the waves may penetrate structures sufficiently for a macro cell to provide service to the UEs 115 located indoors. The transmission of UHF waves may be associated with smaller antennas and shorter ranges (e.g., less than 100 kilometers) compared to transmission using the smaller frequencies and longer waves of the high frequency (HF) or very high frequency (VHF) portion of the spectrum below 300 MHz.

The wireless communications system 100 may utilize both licensed and unlicensed radio frequency spectrum bands. For example, the wireless communications system 100 may employ License Assisted Access (LAA), LTE-Unlicensed (LTE-U) radio access technology, or NR technology in an unlicensed band such as the 5 GHz industrial, scientific, and medical (ISM) band. When operating in unlicensed radio frequency spectrum bands, devices such as the base stations 105 and the UEs 115 may employ carrier sensing for collision detection and avoidance. In some examples, operations in unlicensed bands may be based on a carrier aggregation configuration in conjunction with component carriers operating in a licensed band (e.g., LAA). Operations in unlicensed spectrum may include downlink transmissions, uplink transmissions, P2P transmissions, or D2D transmissions, among other examples.

A base station 105 or a UE 115 may be equipped with multiple antennas, which may be used to employ techniques such as transmit diversity, receive diversity, multiple-input multiple-output (MIMO) communications, or beamforming. The antennas of a base station 105 or a UE 115 may be located within one or more antenna arrays or antenna panels, which may support MIMO operations or transmit or receive beamforming. For example, one or more base station antennas or antenna arrays may be co-located at an antenna assembly, such as an antenna tower. In some examples, antennas or antenna arrays associated with a base station 105 may be located in diverse geographic locations. A base station 105 may have an antenna array with a number of rows and columns of antenna ports that the base station 105 may use to support beamforming of communications with a UE 115. Likewise, a UE 115 may have one or more antenna arrays that may support various MIMO or beamforming operations. Additionally or alternatively, an antenna panel may support radio frequency beamforming for a signal transmitted via an antenna port.

Beamforming, which may also be referred to as spatial filtering, directional transmission, or directional reception, is a signal processing technique that may be used at a transmitting device or a receiving device (e.g., a base station 105, a UE 115) to shape or steer an antenna beam (e.g., a transmit beam, a receive beam) along a spatial path between the transmitting device and the receiving device. Beamforming may be achieved by combining the signals communicated via antenna elements of an antenna array such that some signals propagating at particular orientations with respect to an antenna array experience constructive interference while others experience destructive interference. The adjustment of signals communicated via the antenna elements may include a transmitting device or a receiving device applying amplitude offsets, phase offsets, or both to signals carried via the antenna elements associated with the device. The adjustments associated with each of the antenna elements may be defined by a beamforming weight set associated with a particular orientation (e.g., with respect to the antenna array of the transmitting device or receiving device, or with respect to some other orientation).

The wireless communications system 100 may be a packet-based network that operates according to a layered protocol stack. In the user plane, communications at the bearer or Packet Data Convergence Protocol (PDCP) layer may be IP-based. A Radio Link Control (RLC) layer may perform packet segmentation and reassembly to communicate over logical channels. A Medium Access Control (MAC) layer may perform priority handling and multiplexing of logical channels into transport channels. The MAC layer may also use error detection techniques, error correction techniques, or both to support retransmissions at the MAC layer to improve link efficiency. In the control plane, the Radio Resource Control (RRC) protocol layer may provide establishment, configuration, and maintenance of an RRC connection between a UE 115 and a base station 105 or a core network 130 supporting radio bearers for user plane data. At the physical layer, transport channels may be mapped to physical channels.

The UEs 115 and the base stations 105 may support retransmissions of data to increase the likelihood that data is received successfully. Hybrid automatic repeat request (HARQ) feedback is one technique for increasing the likelihood that data is received correctly over a communication link 125. HARQ may include a combination of error detection (e.g., using a cyclic redundancy check (CRC)), forward error correction (FEC), and retransmission (e.g., automatic repeat request (ARQ)). HARQ may improve throughput at the MAC layer in poor radio conditions (e.g., low signal-to-noise conditions). In some examples, a device may support same-slot HARQ feedback, where the device may provide HARQ feedback in a specific slot for data received in a previous symbol in the slot. In other cases, the device may provide HARQ feedback in a subsequent slot, or according to some other time interval.

In some examples, a UE 115 (e.g., a full duplex UE) may identify a feedback channel configuration (e.g., from a base station 105, etc.) that maps multiple sub-channels of a sidelink channel to feedback resources of a feedback channel of the sidelink channel. The UE 115 may receive control signaling (e.g., from a second UE 115) that schedules the UE 115 to transmit or receive a first sidelink message in a first sub-channel of the sub-channels. The UE 115 may assign a first feedback resource of the feedback resources for transmission or reception of feedback for the first sidelink message that differs from a default resource indicated by the feedback channel configuration. The UE 115 may transmit or receive feedback data for the first sidelink message in the first feedback resource of the feedback channel based on the assigning.

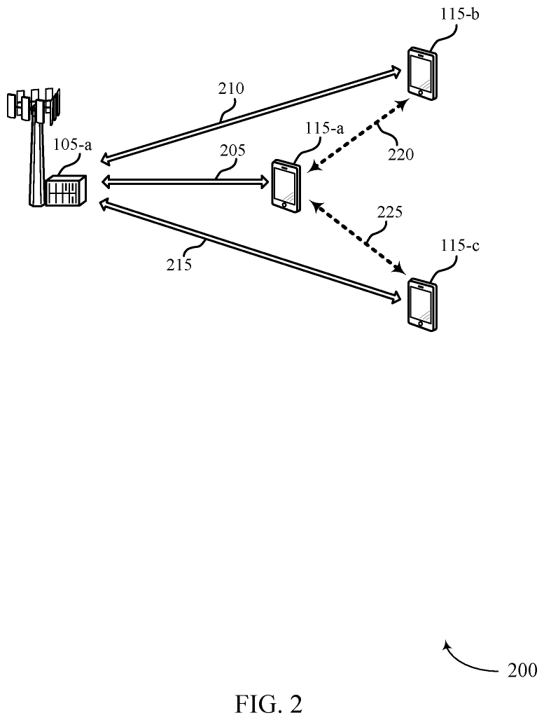

FIG. 2 illustrates an example of a wireless communication system 200 that supports adaptive feedback methods for subband full duplex systems in accordance with aspects of the present disclosure.

As illustrated, wireless communications system 200 may include UE 115-a, UE 115-b, UE 115-c, and base station 105-a, any of which may be an example of a UE 115 or a base station 105, respectively, as described herein with reference to FIG. 1. Wireless communications system 200 may also include a direct link 205 between base station 105-a and UE 115-a, a direct link 210 between base station 105-a and UE 115-b, and a direct link 215 between base station 105-a and UE 115-c. Wireless communications system 200 may also include a sidelink 220 between UE 115-a and UE 115-b and a sidelink 225 between UE 115-a and UE 115-c. In some examples, direct link 205, direct link 210, and direct link 215 may each include a downlink and an uplink. In some examples, base station 105-a may use the downlink of direct link 205 to convey control and/or data information to UE 115-a. And UE 115-a may use the uplink of direct link 205 to convey control or data information to base station 105-a. In some cases, the downlink of direct link 205 may use different time and/or frequency resources than the uplink of direct link 205. In some cases, UE 115-a may use sidelink 220 to convey control and/or data information to UE 115-b, while UE 115-b may use sidelink 220 to convey control or data information to UE 115-a. In some cases, UE 115-a may use sidelink 225 to convey control and/or data information to UE 115-c, while UE 115-c may use sidelink 225 to convey control or data information to UE 115-a.

In some examples, UE 115-a may be a full duplex UE (e.g., subband based full duplex UE). UE 115-b may be a full duplex UE or a half-duplex UE, and UE 115-c may be a full duplex UE or a half-duplex UE. In some cases, UE 115-a, or UE 115-b, or UE 115-c, or any combination thereof, may receive a feedback channel configuration (e.g., from base station 105-a) for a sidelink channel. In some cases, UE 115-a control message (e.g., from base station 105-a) may indicate the feedback channel configuration.

In some examples, UE 115-a may transmit a feedback to or receive a feedback from other full duplex UEs or half duplex UEs (e.g., UE 115-b, UE 115-c). UE 115-a may be configured to leverage its subband full duplex capability in relation to feedback (e.g., HARQ feedback) transmissions and receptions. In some cases, one or more feedback resources may be allocated on which UE 115-a may transmit or receive feedback. In some cases, each resource may contain a physical resource block or two or more contiguous physical resource blocks (PRBs).

In some examples, UE 115-a may adaptively determine or identify feedback resources to transmit feedback on to increase or maximize the amount of feedback transmissions at any time (e.g., satisfy a feedback transmissions threshold over a given time period). In some cases, UE 115-a may adaptively determine or identify feedback resources to receive feedback on to increase or maximize the amount of feedback receptions at any time (e.g., satisfy a feedback receptions threshold over a given time period). In some cases, UE 115-a may adaptively select a resource to be configured as a guard band (e.g., adapting based on the number of available resources, adapting based on whether the feedback is from or for a full duplex or half duplex device, adapting based on the number of available resources, adapting based on whether there are resource available for transmitting feedback and receiving feedback consecutively or concurrently, etc.). In some cases, UE 115-a may select a resource to be configured as a guard band based on a priority (e.g., an absolute priority) of a transmission feedback message on the resource or based on a priority (e.g., an absolute priority) of a reception feedback message on the resource. In some cases, UE 115-a may determine whether to transmit or receive on a feedback resource based on a priority of the message for which the feedback is to be transmitted or received, or an ability of UE 115-a to enable transmission and reception of feedback concurrently, or whether feedback transmission or reception (e.g., either transmission or reception) is to be prioritized on a feedback resource.

In some examples, the feedback channel configuration may indicate feedback resources for a feedback channel of a sidelink channel. In some cases, the feedback channel configuration may indicate where the feedback resources are located in the time domain resources and frequency domain resources of a sidelink channel (e.g., at a symbol of a slot, at a last symbol of a slot, spanning some number of sub-channels, etc.). In some cases, the feedback channel configuration may indicate default locations of one or more feedback resources. In some cases, the feedback channel configuration may indicate a location (e.g., default location) of one or more transmit feedback resources, or a location (e.g., default location) of one or more receive feedback resources, or a location (e.g., default location) of one or more guard bands, or any combination thereof.

In some examples, the sidelink channel may include feedback resources reserved for transmitting feedback on received messages, and include feedback resources reserved for receiving feedback on transmitted messages. In some cases, UE 115-a may use a sidelink channel (e.g., physical sidelink shared channel) to transmit a message to UE 115-b via sidelink 220 or transmit a message to UE 115-c via sidelink 225. In some examples, UE 115-b may use a sidelink channel to transmit a message to UE 115-a via sidelink 220, or UE 115-c may use a sidelink channel to transmit a message to UE 115-a via sidelink 225. In some cases UE 115-a may use the feedback resources of the sidelink channel to transmit feedback for a message that UE 115-a receives from UE 115-b over sidelink 220 or transmit feedback for a message that UE 115-a receives from UE 115-c over sidelink 225. In some cases, UE 115-a may use the feedback resources of the sidelink channel to receive feedback for a message that UE 115-a transmits to UE 115-b over sidelink 220, or receive feedback for a message that UE 115-a transmits to UE 115-c over sidelink 225.

In some examples, UE 115-a may determine that the feedback channel configuration maps multiple sub-channels of a sidelink channel to the feedback resources of a feedback channel of the sidelink channel. In some cases, UE 115-a may receive control signaling from UE 115-b or UE 115-c (e.g., based on UE 115-a receiving a message from or transmitting a message to UE 115-b or UE 115-c, etc.). The control signaling may schedule UE 115-a to transmit or receive a first sidelink message in a first sub-channel of the multiple sub-channels. In some cases, UE 115-a may assign a first feedback resource of the multiple feedback resources for transmission or reception of feedback for the first sidelink message that differs from a default resource identified by the feedback channel configuration. In some cases, UE 115-a may assign the first feedback resource for transmission of feedback where the feedback channel configuration identifies the first feedback resource for reception of feedback. UE 115-a may then transmit feedback data for the first sidelink message in the first feedback resource of the feedback channel based on the dynamic assigning.

The present techniques increase spectral efficiency and data throughput of one or more devices (e.g., battery-operated devices, a UE 115 of FIG. 1 or 2) by providing support for full duplex UEs in half-duplex wireless systems (e.g., half-duplex V2X systems). By efficiently leveraging the capability of full duplex UEs in half-duplex wireless systems, the present techniques improve user experience of the one or more devices, decrease system latency, and increase quality of service.

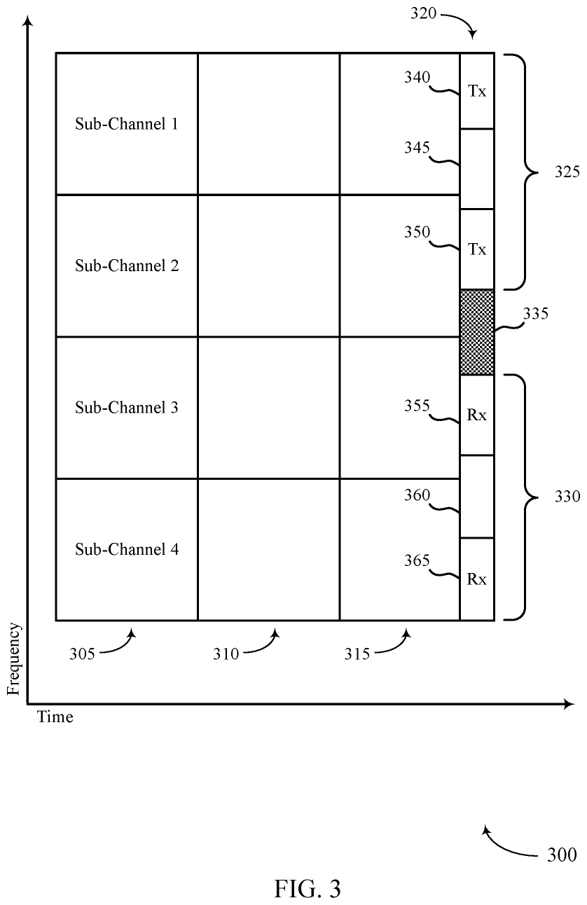

FIG. 3 illustrates an example of a configuration 300 of a sidelink channel that supports adaptive feedback methods for subband full duplex systems in accordance with aspects of the present disclosure.

In the illustrated example, configuration 300 depicts frequency domain and time domain resources of a sidelink channel. The configuration 300 may include resources that a UE uses to transmit control message or data messages, or both (e.g., sub-channels), and resources that a UE may use to receive feedback on message transmitted via the sub-channels, and transmit feedback on messages received via the sub-channels.

In the illustrated example, configuration 300 includes slot 305, slot 310, and slot 315. In some cases, each slot may include one or more sub-channels (e.g., slot 305 may include sub-channel 1, sub-channel 2, sub-channel 3, sub-channel 4, etc.). As shown, a symbol of slot 315 may be configured to include feedback resources 320 (e.g., of a feedback channel of the sidelink channel). The feedback resources 320 may include a transmit sub-band 325 (e.g., a sub-band of multiple transmit feedback resources), and a receive sub-band 330 (e.g., a sub-band of multiple receive feedback resources). As shown, guard band 335 may be positioned between transmit sub-band 325 and receive sub-band 330.

In some examples, a UE (e.g., a UE 115 as described herein) may receive a feedback channel configuration from a base station (e.g., from a base station 105 as described herein). In some cases, the feedback channel configuration may indicate feedback resources 320. The feedback channel configuration may indicate that the feedback resources 325 are located at a symbol of slot 315 (e.g., at a last symbol of slot 315). In some cases, the feedback channel configuration may indicate a mapping between sub-channels (e.g., sub-channels of slot 305) and the feedback resources 320.

In some examples, the UE may adaptively or dynamically determine resource blocks 340, 345, and 350 are transmit feedback resources, and that resource blocks 355, 360, and 365 are receive feedback resources. the UE may adapt the amount of transmit feedback resources or receive feedback resources in transmit/receive subbands on a per slot basis. In some cases, the UE may assign feedback resource 340 of feedback resources 320 for feedback reception, which may differ from a default configuration of the feedback channel configuration that identifies feedback resource 340 for feedback transmission. In some cases, the UE may assign feedback resource 355 of feedback resources 320 for feedback transmission, which may differ from a default configuration of the feedback channel configuration that identifies feedback resource 355 for feedback reception.

In the illustrated example, a “Tx” depicted inside resource block 340 indicates the UE intends to use that feedback resource to transmit a feedback, while an “Rx” depicted inside a box indicates the UE intends to use that feedback resource to receive a feedback. Since resource block 345 has Tx boxes on either side, this indicates the UE intends to use that feedback resource to transmit a feedback (e.g., to avoid leakage between transmit and feedback resources). Since resource block 360 has Rx boxes on either side, this indicates the UE intends to use that feedback resource to receive a feedback (e.g., to avoid leakage between transmit and feedback resources). In the illustrated example, there is no mismatch between how the UE intends to use a resource block and the resulting transmit and receive subband selections.

In some cases, the position of transmit sub-band 325 may be based on a default position of transmit feedback resources indicated by the feedback channel configuration. In some cases, the position of receive sub-band 330 may be based on a default position of receive feedback resources indicated by the feedback channel configuration. In some cases, the position of guard band 335 may be based on a default position of guard band resources indicated by the feedback channel configuration. In some cases, the UE may configure the feedback resources 320 according to the feedback channel configuration. In some cases, the UE may modify one or more aspects of the feedback resources 320 that differ from how the feedback resources 320 are indicated by the feedback channel configuration.

In some examples, the UE may receive control signaling that schedules the UE to transmit a sidelink message in a sub-channel (e.g., a sub-channel 1 of slot 315). In some examples, the UE may dynamically assign a feedback resource of feedback resources 320 for reception of feedback for the sidelink message that differs from a default resource identified by the feedback channel configuration (e.g., assign a feedback resource of transmit sub-band 325 to receive feedback). The UE may then receive feedback data for the sidelink message in the dynamically assigned feedback resource.

In some examples, the UE may receive control signaling that schedules the UE to receive a sidelink message in a sub-channel (e.g., a sub-channel of slot 315). In some examples, the UE may dynamically assign feedback resource 355 of receive sub-band 330 for transmission of feedback for the sidelink message, which differs from the default configuration for feedback resource 355 as a receive feedback resource as identified by the feedback channel configuration. The UE may then transmit feedback data for the sidelink message based on the dynamic assignment of feedback resource 355 as a transmit feedback resource.

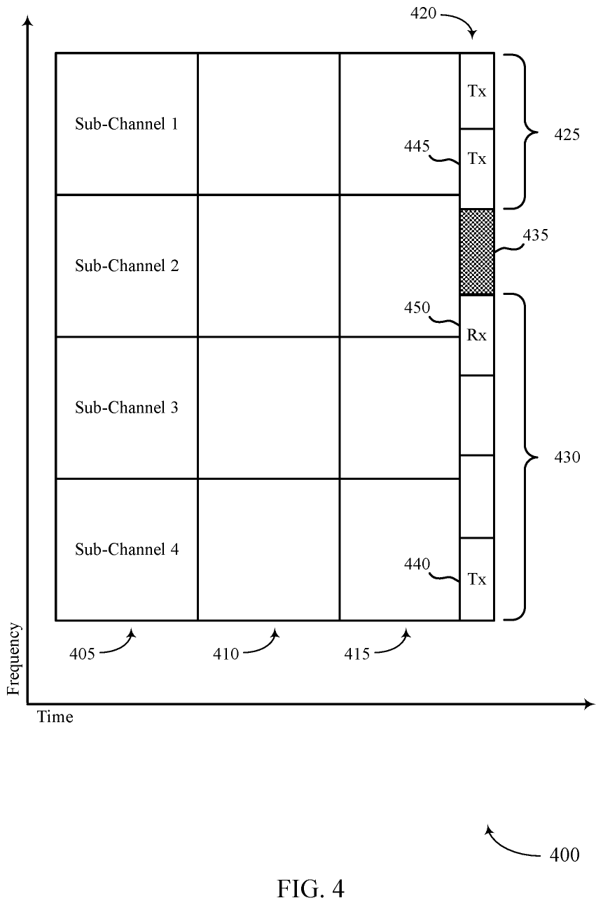

FIG. 4 illustrates an example of a configuration 400 of a sidelink channel that supports adaptive feedback methods for subband full duplex systems in accordance with aspects of the present disclosure.

In the illustrated example, configuration 400 includes slot 405, slot 410, and slot 415. In some cases, each slot may include one or more sub-channels (e.g., slot 405 may include sub-channel 1, sub-channel 2, sub-channel 3, sub-channel 4, etc.). As shown, a symbol of slot 415 may be configured to include feedback resources 420 (e.g., of a feedback channel of the sidelink channel). The feedback resources 420 may include a transmit sub-band 425 and a receive sub-band 430. As shown, guard band 435 may be positioned between transmit sub-band 425 and receive sub-band 430. In some examples, the UE may dynamically assign each feedback resource of feedback resources 420 for transmission or reception of feedback for respective sidelink messages based on a priority of each sidelink message. In the illustrated example, the UE may select the locations of transmit sub-band 425, or receive sub-band 430, or guard band 435, or any combination thereof. In the provided example, the UE has selected one sub-band for feedback transmissions (e.g., transmit sub-band 425) and one sub-band for feedback receptions (e.g., receive sub-band 430). In some cases, a UE may select multiple sub-bands for feedback transmissions, or multiple sub-bands for feedback receptions, or multiple guard bands between transmit feedback resources and receive feedback resources.

In some examples, a UE may select transmit and receive subbands that are not fully matched with its intended transmit/receive resource (e.g., according to a feedback channel configuration). In some cases, in receive subband 430, there may be a feedback resource 450 configured for feedback reception on which the UE intends to transmit. In some cases, the UE may be configured to transmit or receive feedback for sub-channel 1 in feedback resource 435, which is configured as a guard band. As discussed herein, the UE may change the default resource assignment of feedback resource 435 as a guard band to increase the number of transmit or receive feedback resources. When the UE uses resource block 435 to transmit feedback, the UE may configure resource block 450 as a guard band to avoid leakage. When the UE uses resource block 435 to receive feedback, the UE may configure resource block 445 as a guard band to avoid leakage.

In some examples, the selections of the transmit sub-band 425, receive sub-band 430, and guard band 435 by the UE may result in variations between the bandwidths of the transmit sub-band 425 and the receive sub-band 430. In some cases, the number of transmit feedback resources allocated to a transmit subband and the number of receive feedback resources allocated to a receive subband may be selected by the UE to increase or maximize the number of feedbacks (e.g., HARQ feedbacks) that the UE transmits and receives at a given slot. In some cases, the UE may select the bandwidths of the transmit sub-band 425 (e.g., number of transmit feedback resources) and the receive sub-band 430 (e.g., number of receive feedback resources) to increase or maximize the number of feedbacks transmitted and received at slot 415. In the illustrated example, the UE selects the bandwidth of receive sub-band 430 to exceed the bandwidth of transmit sub-band 425. For example, the UE may increase or maximize the number of receive feedback resources provided that the number of transmit resources satisfies a threshold (e.g., meets or exceeds a threshold). In another example, the UE may increase or maximize the number of transmit feedback resources provided that the number of receive resources satisfies a threshold (e.g., meets or exceeds a threshold).

In some examples, the UE may select a feedback resource of receive sub-band 430 to transmit feedback, or may select a feedback resource of transmit sub-band 425 to receive feedback. As shown, UE may select feedback resource 440 of receive sub-band 430 to transmit feedback. The UE may then use feedback resource 440 to transmit the feedback for a message that the UE has received.

In some examples, the UE may receive, via sub-channel 1, a first sidelink message and a second sidelink message. In some cases, the UE may receive the first sidelink message in a first transmission time interval (e.g., in slot 405) and receive the second sidelink message in a second transmission time interval (e.g., slot 410) different from the first transmission time interval. In some cases, the first sidelink message and the second sidelink message may each correspond to the same feedback resource (e.g., feedback resource 440). Accordingly, the UE may determine on which one of the first sidelink message or the second sidelink message to transmit feedback for in feedback resource 440. In some cases, the UE may select on which of the first sidelink message or the second sidelink message to provide feedback based on a priority of the first sidelink message relative to a priority of the second sidelink message. When the priority of the first sidelink message exceeds the priority of the second sidelink message, the UE may use feedback resource 440 to transmit the feedback for the first sidelink message (e.g., dropping feedback transmission for the second sidelink message). When the priority of the second sidelink message exceeds the priority of the first sidelink message, the UE may use feedback resource 440 to transmit the feedback for the second sidelink message (e.g., dropping feedback transmission for the first sidelink message).

In some examples, the UE may receive, via sub-channel 1 of slot 405, a first sidelink message, and may transmit a second sidelink message in sub-channel 1 or in sub-channel 2. In some cases, the first sidelink message and the second sidelink message may each correspond or map to feedback resource 440. In some cases, UE may determine whether to use feedback resource 440 to transmit feedback for the first sidelink message or use feedback resource 440 to receive feedback for the second sidelink message. In some cases, the UE may transmit feedback for the first sidelink message or receive feedback for the second sidelink message based on a priority of the first sidelink message relative to a priority of the second sidelink message. When the priority of the first sidelink message exceeds the priority of the second sidelink message, the UE may use feedback resource 440 to transmit the feedback for the first sidelink message (e.g., dropping feedback reception for the second sidelink message). When the priority of the second sidelink message exceeds the priority of the first sidelink message, the UE may use feedback resource 440 to receive the feedback for the second sidelink message (e.g., dropping feedback transmission for the first sidelink message).

In some cases, the UE may receive first control signaling scheduling the UE to transmit or receive a first sidelink message in sub-channel 1 of slot 405. In some cases, the UE may receive second control signaling scheduling the UE to transmit or receive a second sidelink message in sub-channel 2 of slot 405. In some cases, the UE may communicate (e.g., transmit or receive) second feedback data for the second sidelink message on feedback resource 440 (e.g., instead of or in addition to communicating feedback data for the first sidelink message) based on a priority of the second sidelink message relative to a priority of the first sidelink message.

In some examples, the UE may transmit the feedback data for the first sidelink message on transmit feedback resource 445 and receive second feedback data for a second sidelink resource on receive feedback resource 450 having guard band 435 between the transmit feedback resource 445 and the receive feedback resource 450. In some cases, a feedback channel configuration may indicate a first location of guard band 435 within feedback resources 420 that differs from the location (e.g., second location) of guard band 435 as shown. In some cases, the UE may select the depicted location of guard band 435.

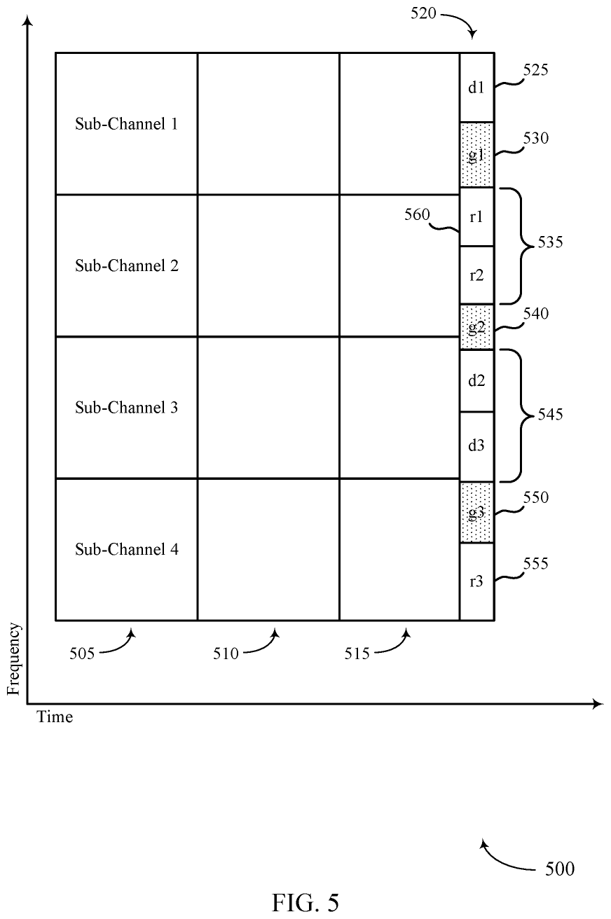

FIG. 5 illustrates an example of a configuration 500 of a sidelink channel that supports adaptive feedback methods for subband full duplex systems in accordance with aspects of the present disclosure.

In the illustrated example, configuration 500 includes slot 505, slot 510, and slot 515. In some cases, each slot may include one or more sub-channels (e.g., slot 505 may include sub-channel 1, sub-channel 2, sub-channel 3, sub-channel 4, etc.). As shown, a symbol of slot 515 may be configured to include feedback resources 520 (e.g., of a feedback channel of the sidelink channel). The feedback resources 520 may include feedback resources selected and configured by a UE. In the illustrated example, the UE selects multiple guard bands to avoid leakage between transmit feedback resources and receive feedback resources. As shown, the feedback resources 520 may include a feedback resource 525 configured as a transmit feedback resource, a feedback resource 530 configured as a first guard band, receive sub-band 535, a feedback resource 540 configured as a second guard band, transmit sub-band 545, a feedback resource 550 configured as a third guard band, and a feedback resource 555 configured as a receive feedback resource.

In some examples, determined transmit and receive feedback resource may be separated by guard bands. As shown, feedback resource 525 configured to transmit feedback and feedback resource 560 configured to receive feedback are separated by feedback resource 530 configured as a first guard band. However, if two consecutive feedback resources are configured to receive feedback (e.g., receive feedback resources of receive sub-band 535), or if two consecutive feedback resources are configured to transmit feedback (e.g., transmit feedback resources of transmit sub-band 545), then the adjacent feedback resources may be configured without a guard band between them. Accordingly, receive feedback resources of receive sub-band 535 and transmit feedback resources of transmit sub-band 545 are separated by feedback resource 540 configured as a second guard band, transmit feedback resources of transmit sub-band 545 and feedback resource 555 configured as a receive feedback resource are separated by feedback resource 550 configured as a third guard band.

In some examples, feedback resource 525 may be configured for transmission of feedback (e.g., according to a feedback channel configuration). In some cases, a UE may configure feedback resource 525 for a feedback transmission based on a priority of a sidelink message that the UE receives on sub-channel 1 and that corresponds to feedback resource 525. In some examples, the UE may transmit a sidelink message on sub-channel 1 and may assign feedback resource 525 for reception of feedback for the sidelink message that UE transmits on sub-channel 1. In some cases, the UE may assign feedback resource 525 for reception of feedback based on a priority of the sidelink message that UE transmits on sub-channel 1, or based on a priority of feedback transmissions relative to a priority of feedback receptions, based on feedback resource 530 being configured as a guard band, or any combination thereof.

In some examples, a UE may be configured to prioritize transmit feedback resources 525 and 545 over receive feedback resources 535 and 555, or to prioritize receive feedback resources 535 and 555 over transmit feedback resources 525 and 545. In some cases, a UE may be configured to assign transmit feedback resources 525 and 545 to satisfy a transmit threshold, and then assign a remaining amount of feedback resources to receive feedback resources 535 and 555 with guard bands 530, 540, and 550 between the transmit feedback resources 525 and 545 and receive feedback resources 535 and 555. In some cases, a UE may be configured to assign receive feedback resources 535 and 555 to satisfy a receive threshold, and then assign a remaining amount of feedback resources to transmit feedback resources 525 and 545 with guard bands 530, 540, and 550 between the transmit feedback resources 525 and 545 and receive feedback resources 535 and 555. In some cases, the UE may receive a sidelink message on sub-channel 4 and assign feedback resource 555 for transmission of feedback for the sidelink message (e.g., that differs from feedback resource 555 being configured as a receive feedback resource as indicated in the feedback channel configuration) based on a location of feedback resource 550 being configured guard band g3 (e.g., as originally assigned by the UE within feedback resources 520 or as indicated by the feedback channel configuration).

In some examples, a feedback channel configuration may indicate that feedback resource 525 is a receive feedback resource. In some cases, The LIE may configure feedback resource 525 according to the feedback channel configuration (e.g., as a receive feedback resource based on the priority of the sidelink message). In the illustrated example, the UE may configure feedback resource 525 to be a transmit feedback resource (e.g., based on the priority of an associated sidelink message), and configure feedback resource 555 to be a receive feedback resource (e.g., based on the priority of an associated sidelink message). In some cases, the UE may configure feedback resource 525 to be a transmit feedback resource, while the feedback channel configuration indicated feedback resource 525 is a receive feedback resource or a guard band. In some cases, the UE may configure feedback resource 555 to be a receive feedback resource, while the feedback channel configuration indicated feedback resource 525 is a transmit feedback resource or a guard band. In some cases, the UE may configure feedback resource 530 to be a guard band, while the feedback channel configuration indicated feedback resource 530 is a transmit feedback resource or a receive feedback resource.

In some examples, the UE may transmit feedback for a first sidelink message in feedback resource 525 based on using feedback resource 530 as a first guard band. In some cases, the feedback channel configuration indicates the feedback resource 530 is a transmit feedback resource or a receive feedback resource. In some examples, the UE may receive feedback for a second sidelink message in feedback resource 555 based on using feedback resource 550 as a third guard band. In some cases, the feedback channel configuration indicates the feedback resource 550 is a transmit feedback resource or a receive feedback resource.

In some examples, a guard band may be determined based on a priority (e.g., an absolute priority) of a feedback message to be transmitted or received on a corresponding resource. In some cases, a UE may receive a first sidelink message on sub-channel 1 with a priority p1, and may transmit a second sidelink message on sub-channel 1 with a priority p2. In some cases, the first sidelink message and the second sidelink message may correspond with feedback resource 530, which is configured as a guard band. In some cases, the UE may determine whether the priority (e.g., absolute priority) associated with the first sidelink message and the second sidelink message allows feedback resource 530 to be used for transmission or reception of feedback. With the absolute priority p=max (p1, p2), when the priority (e.g., absolute priority) p is less than a priority threshold p0 (e.g., p<p0), then the UE may maintain feedback resource 530 as a guard band. When the priority (e.g., absolute priority) p is greater than the priority threshold p0 (e.g., p>p0), then the UE may allow feedback resource 530 to be used for transmission or reception of feedback. When p1 is greater than p2, then the UE may configure feedback resource 530 to transmit feedback for the first sidelink message. When p2 is greater than p1, then the UE may configure feedback resource 530 to receive feedback for the second sidelink message. When the absolute priority p is equal to the priority threshold p0 (e.g., p=p0), then the UE may maintain feedback resource 530 as a guard band or allow feedback resource 530 to be used for transmission or reception of feedback based on a configuration of the UE.

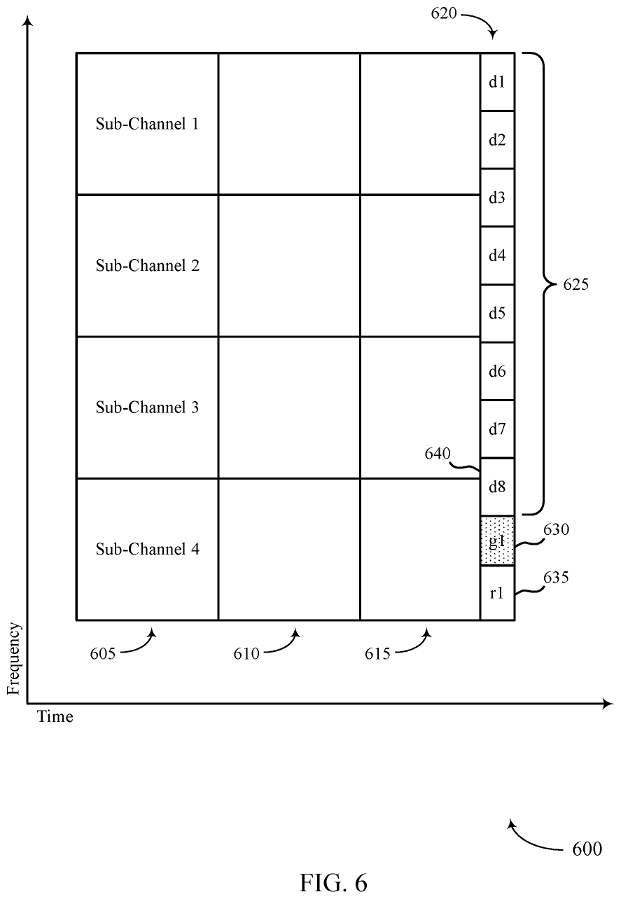

FIG. 6 illustrates an example of a configuration 600 of a sidelink channel that supports adaptive feedback methods for subband full duplex systems in accordance with aspects of the present disclosure.

In the illustrated example, configuration 600 includes slot 605, slot 610, and slot 615. In some cases, each slot may include one or more sub-channels (e.g., slot 605 may include sub-channel 1, sub-channel 2, sub-channel 3, sub-channel 4, etc.). As shown, a symbol of slot 615 may be configured to include feedback resources 620 (e.g., of a feedback channel of the sidelink channel). The feedback resources 620 may include feedback resources selected and configured by a UE. In the illustrated example, the UE may configure feedback resources 620 to include transmit sub-band 625 (e.g., a sub-band of multiple transmit feedback resources d1 through d8). Feedback resources 620 may also include feedback resource 630 and feedback resource 635. As shown, the UE may configure feedback resource 635 as a receive feedback resource, and configure feedback resource 630 as a guard band to avoid leakage between transmit sub-band 625 and feedback resource 635 configured as a receive feedback resource.

In some examples, the UE may select (e.g., independently select) feedback resource 635 to be a transmit feedback resource or a receive feedback resource based on the priority of transmit feedback message or a receive feedback message in relation to available feedback resources. In some cases, the UE may select feedback resource 635 to be a transmit feedback resource or a receive feedback resource based on feedback resource 630 being configured as a guard band. In some cases, the UE may select feedback resource 635 to be a transmit feedback resource or a receive feedback resource based on an adjacent feedback resource. In the illustrated example, the UE may select feedback resource 640 to be a transmit feedback resource and feedback resource 630 to be a guard band. In response to these configurations, the UE may configure feedback resource 635 as a receive feedback resource.

In some examples, the UE may select feedback resource 630 to be configured as a guard band based on feedback resource 635 being configured as receive feedback resource. In the illustrated example, the UE may select feedback resource 640 to be a transmit feedback resource and feedback resource 635 to be a receive feedback resource. In response to these configurations, the UE may configure feedback resource 630 as a guard band to avoid leakage between feedback resource 635 and feedback resource 630 if feedback resource 630 had otherwise been configured as a transmit feedback resource, or to avoid leakage between feedback resource 640 and feedback resource 630 if feedback resource 630 had otherwise been configured as a receive feedback resource.

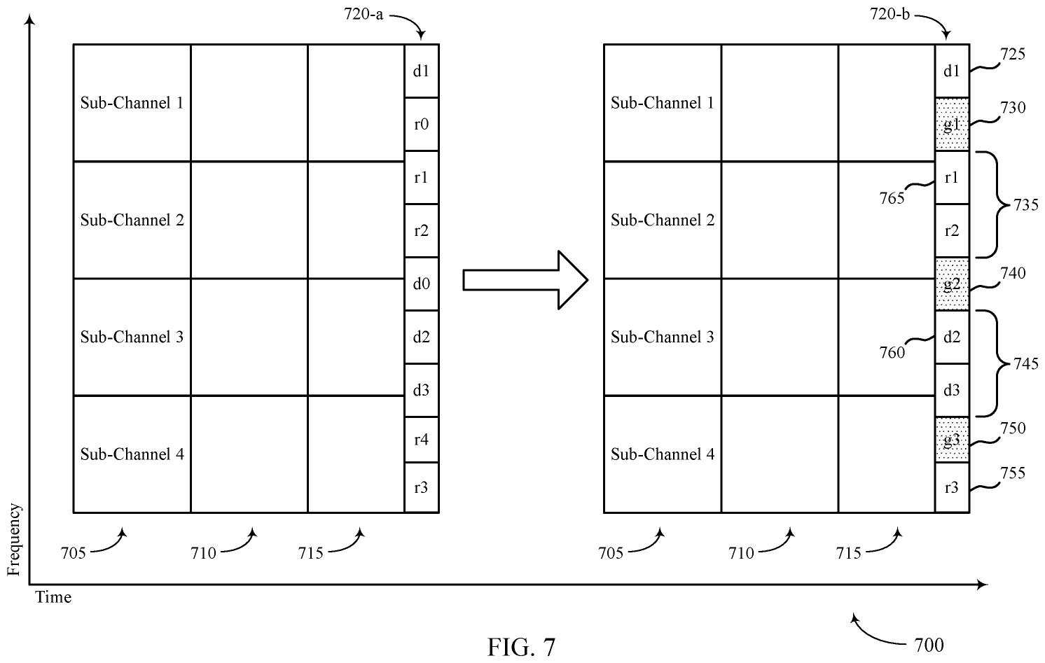

FIG. 7 illustrates an example of a configuration 700 of a sidelink channel that supports adaptive feedback methods for subband full duplex systems in accordance with aspects of the present disclosure.

In the illustrated example, configuration 700 includes slot 705, slot 710, and slot 715. In some cases, each slot may include one or more sub-channels (e.g., slot 705 may include sub-channel 1, sub-channel 2, sub-channel 3, sub-channel 4, etc.). As shown, a symbol of slot 715 may be configured to include feedback resources 720 (e.g., of a feedback channel of the sidelink channel). In the illustrated example, configuration 700 may include a first instance of feedback resources 720 (e.g., feedback resources 720-a) and a second instance of feedback resources 720 (e.g., feedback resources 720-b) that is based on a modification of the first instance.

The feedback resources 720 may include feedback resources selected and configured by a UE. In the illustrated example, the UE may configure feedback resources 720-a to include multiple transmit feedback resources (e.g., d0, d1, d2, d3) and multiple receive feedback resources (e.g., r0, r1, r2, r3, r4). As shown, feedback resources 720-a may be configured without guard bands between transmit feedback resources and receive feedback resources.

In the illustrated example, the UE may configure one or more aspects of feedback resources 720-a, which may include the UE selecting a resource to be a transmit resource, or a receive resource, or a guard band based on the priority of a transmit feedback message with respect to that resource or another resource, or based on a priority of a receive feedback message with respect to that resource or another resource, or based on a priority of feedback transmissions over feedback receptions generally, or based on a priority of feedback receptions over feedback transmissions generally, or some combination thereof. In some cases, feedback resources 720-b may represent the resources of feedback resources 720 after UE has configured feedback resources 720-a.

As shown, the UE may configure feedback resources 720-b to include one or more guard bands. As shown, the UE may configure feedback resource 730 as a first guard band (e.g., switching it from a receive feedback resource r0 to a first guard band g1) to separate feedback resource 725 configured as a transmit feedback resource from receive sub-band 735 (e.g., to avoid leakage). The UE may configure feedback resource 740 as a second guard band (e.g., switching it from a transmit feedback resource d0 to a second guard band g2) to separate receive sub-band 735 from transmit sub-band 745 (e.g., to avoid leakage). The UE may configure feedback resource 750 as a third guard band (e.g., switching it from a receive feedback resource r4 to a third guard band g3) to separate transmit sub-band 745 from feedback resource 755 configured as a receive feedback resource.

In some examples, the UE may configure feedback resources 720 based on one or more conditions (e.g., constraints). The one or more conditions (e.g., constraints) may include increasing or maximizing the number of transmit feedback resources in a given slot, or increasing or maximizing the number of receive feedback resources in a given slot. The one or more conditions (e.g., constraints) may include the number of transmit feedback resources in a given slot satisfying a transmit threshold and the remaining feedback resources being configured as receive feedback resources with a guard band between, or the number of receive feedback resources in a given slot satisfying a receive threshold and the remaining feedback resources being configured as transmit feedback resources with a guard band between. As shown in FIG. 6, when the receive threshold equals one, then one feedback resource (e.g., feedback resource 635) may be configured as a receive feedback resource, and then with the receive threshold satisfied the remaining feedback resources may be configured as transmit feedback resources, with a guard band between (e.g., feedback resource 630 configured as an intervening guard band).

In some examples, the UE may select (e.g., independently select) feedback resource 725 or feedback resources of transmit sub-band 745 for feedback transmission based on a priority of feedback transmission relative to a priority of feedback receptions. In some cases, the UE may select (e.g., independently select) select feedback resource 755 or feedback resources of receive sub-band 735 for feedback reception based on a priority of feedback transmission relative to a priority of feedback receptions. When the UE assigns feedback resource 725 or feedback resources of transmit sub-band 745 for feedback transmission, the UE determines whether any of the one or more conditions (e.g., constraints) are satisfied as a result of the assignment. For example, the UE may whether (1) a condition to increase or maximize the number of transmit or receive HARQ feedback resources in a slot is satisfied; (2) a condition to increase or maximize the number of transmit HARQ feedback resources such that the number of receive feedback resources in a slot satisfies a threshold (e.g., meets or exceeds a threshold); (3) a condition to increase or maximize the number of receive HARQ feedback resources such that the number of transmit feedback resources satisfies a threshold (e.g., meets or exceeds a threshold); or any combination thereof.

When the UE assigns feedback resource 755 or feedback resources of receive sub-band 735 for feedback reception, the UE determines whether any of the one or more conditions (e.g., constraints) are satisfied as a result of the assignment. If the UE determines that at least one condition (e.g., constraint) is satisfied, the UE proceeds with the determined configuration. If the UE determines that none of the one or more conditions (e.g., constraints) are satisfied, the UE may perform one or more additional procedures. In some cases, one or more additional procedures may include a switching procedure where the UE changes a feedback resource 725 to a receive feedback resource, or changes feedback resource 755 to a transmit feedback resource. In some cases, one or more additional procedures may include a guard band insertion procedure where the UE assigns feedback resource 730 as a guard band between feedback resource 725 configured for feedback transmissions and the receive feedback resources of receive sub-band 735 (e.g., to satisfy a configured leakage criterion). In some cases, the guard band insertion procedure may include the UE inserting a guard band within consecutive transmit feedback resources or within consecutive receive feedback resources. In some cases, the UE may configure feedback resource 760 as a guard band inserted between transmit feedback resources. In some cases, the one or more additional procedures may include the UE iteratively performing one or more switching procedures or one or more guard band insertion procedures, or any combination thereof, until at least one of the one or more conditions (e.g., constraints) are satisfied.

In some examples, based on the determined guard band resources (e.g., configuration or absolute priority), the UE may designate the feedback resources of feedback resources 720 to be transmit/receive feedback resources. In some cases, the UE (e.g., a sub-band full duplex (SBFD) UE) compares the priority of messages for which feedback is to be transmitted or received on feedback resources 720 individually, and decides whether to configure feedback resource 725 and the feedback resources of transmit sub-band 745 for feedback transmission and configure feedback resource 755 and the feedback resources of receive sub-band 735 for feedback reception while taking into account the guard band resource condition (e.g., constraint).

In some examples, the UE may determine independently whether to transmit or receive on feedback resource 725 and feedback resource 765 based on a priority of respective messages and the feedback resources configured as guard bands (e.g., feedback resources 730, 740, and 750 configured as guard bands). In some cases, UE configures feedback resource 725 and feedback resource 765 to be separated by guard band g1 (e.g., feedback resource 725 configured for feedback transmissions, feedback resource 765 configured for feedback receptions, and feedback resource 730 configured as the first guard band). In some examples, f1 is a feedback message with priority p1 and assigned to be received on feedback resource 725, f2 is a feedback message with priority p2 and assigned to be transmitted on feedback resource 725, f3 is a feedback message with priority p3 and assigned to be transmitted on feedback resource 765, and f4 is a feedback message with priority p4 and assigned to be received on feedback resource 765, where p1>p2, and where p3<p4. On resource feedback resource 725, as p1>p2, the UE decides to receive feedback. Thus, the UE receives f1 on feedback resource 725 and drops f2. On resource feedback resource 765, as p3<p4, the UE decides to receive feedback. Thus, the UE receives f4 on feedback resource 765 and drops f3. Accordingly, the UE receives feedback in both feedback resource 725 and feedback resource 765. In some cases, since feedback resource 725 and feedback resource 765 are both configured to receive feedback, feedback resource 730 may be configured to match the configuration of feedback resource 725 and feedback resource 765 (e.g., to receive feedback) instead of as a guard band. If feedback resource 725 and feedback resource 765 were both configured to transmit feedback, then feedback resource 730 may be configured to transmit feedback instead of as a guard band.

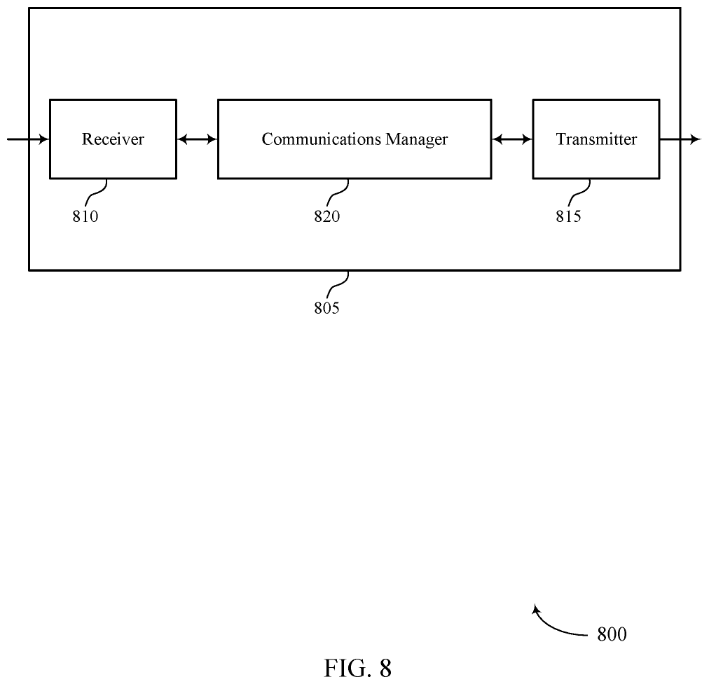

FIG. 8 shows a block diagram 800 of a device 805 that supports adaptive feedback methods for subband full duplex systems in accordance with aspects of the present disclosure. The device 805 may be an example of aspects of a UE 115 as described herein. The device 805 may include a receiver 810, a transmitter 815, and a communications manager 820. The device 805 may also include a processor. Each of these components may be in communication with one another (e.g., via one or more buses).

The receiver 810 may provide a means for receiving information such as packets, user data, control information, or any combination thereof associated with various information channels (e.g., control channels, data channels, information channels related to adaptive feedback methods for subband full duplex systems). Information may be passed on to other components of the device 805. The receiver 810 may utilize a single antenna or a set of multiple antennas.

The transmitter 815 may provide a means for transmitting signals generated by other components of the device 805. For example, the transmitter 815 may transmit information such as packets, user data, control information, or any combination thereof associated with various information channels (e.g., control channels, data channels, information channels related to adaptive feedback methods for subband full duplex systems). In some examples, the transmitter 815 may be co-located with a receiver 810 in a transceiver module. The transmitter 815 may utilize a single antenna or a set of multiple antennas.

The communications manager 820, the receiver 810, the transmitter 815, or various combinations thereof or various components thereof may be examples of means for performing various aspects of adaptive feedback methods for subband full duplex systems as described herein. For example, the communications manager 820, the receiver 810, the transmitter 815, or various combinations or components thereof may support a method for performing one or more of the functions described herein.

In some examples, the communications manager 820, the receiver 810, the transmitter 815, or various combinations or components thereof may be implemented in hardware (e.g., in communications management circuitry). The hardware may include a processor, a digital signal processor (DSP), an application-specific integrated circuit (ASIC), a field-programmable gate array (FPGA) or other programmable logic device, a discrete gate or transistor logic, discrete hardware components, or any combination thereof configured as or otherwise supporting a means for performing the functions described in the present disclosure. In some examples, a processor and memory coupled with the processor may be configured to perform one or more of the functions described herein (e.g., by executing, by the processor, instructions stored in the memory).

Additionally or alternatively, in some examples, the communications manager 820, the receiver 810, the transmitter 815, or various combinations or components thereof may be implemented in code (e.g., as communications management software or firmware) executed by a processor. If implemented in code executed by a processor, the functions of the communications manager 820, the receiver 810, the transmitter 815, or various combinations or components thereof may be performed by a general-purpose processor, a DSP, a central processing unit (CPU), an ASIC, an FPGA, or any combination of these or other programmable logic devices (e.g., configured as or otherwise supporting a means for performing the functions described in the present disclosure).

In some examples, the communications manager 820 may be configured to perform various operations (e.g., receiving, monitoring, transmitting) using or otherwise in cooperation with the receiver 810, the transmitter 815, or both. For example, the communications manager 820 may receive information from the receiver 810, send information to the transmitter 815, or be integrated in combination with the receiver 810, the transmitter 815, or both to receive information, transmit information, or perform various other operations as described herein.

The communications manager 820 may support wireless communication at a full duplex UE in accordance with examples as disclosed herein. For example, the communications manager 820 may be configured as or otherwise support a means for identifying a feedback channel configuration that maps a set of multiple subchannels of a sidelink channel to a set of multiple feedback resources of a feedback channel of the sidelink channel. The communications manager 820 may be configured as or otherwise support a means for receiving control signaling scheduling the full duplex UE to transmit or receive a first sidelink message in a first subchannel of the set of multiple subchannels. The communications manager 820 may be configured as or otherwise support a means for assigning a first feedback resource of the set of multiple feedback resources for transmission or reception of feedback for the first sidelink message that differs from a default resource identified by the feedback channel configuration. The communications manager 820 may be configured as or otherwise support a means for communicating feedback data for the first sidelink message in the first feedback resource of the feedback channel based on the assigning.

By including or configuring the communications manager 820 in accordance with examples as described herein, the device 805 (e.g., a processor controlling or otherwise coupled to the receiver 810, the transmitter 815, the communications manager 820, or a combination thereof) may support techniques for adaptive feedback methods for subband full duplex systems. The described techniques may support improvements in system efficiency and quality of service. The described techniques may result in reduced processing, reduced power consumption, more efficient utilization of communication resources.

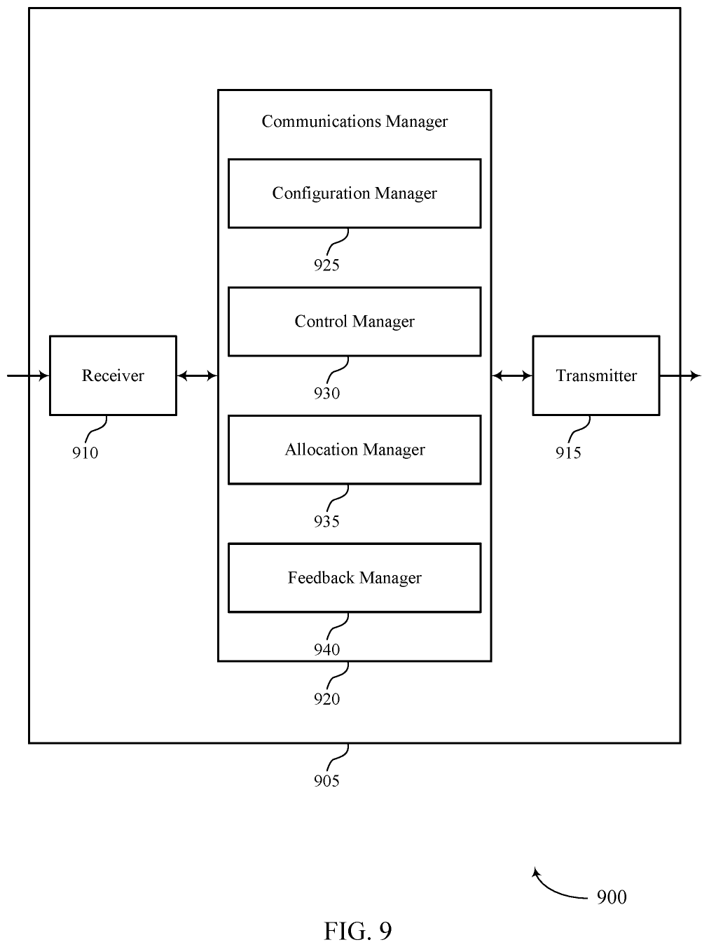

FIG. 9 shows a block diagram 900 of a device 905 that supports adaptive feedback methods for subband full duplex systems in accordance with aspects of the present disclosure. The device 905 may be an example of aspects of a device 805 or a UE 115 as described herein. The device 905 may include a receiver 910, a transmitter 915, and a communications manager 920. The device 905 may also include a processor. Each of these components may be in communication with one another (e.g., via one or more buses).

The receiver 910 may provide a means for receiving information such as packets, user data, control information, or any combination thereof associated with various information channels (e.g., control channels, data channels, information channels related to adaptive feedback methods for subband full duplex systems). Information may be passed on to other components of the device 905. The receiver 910 may utilize a single antenna or a set of multiple antennas.

The transmitter 915 may provide a means for transmitting signals generated by other components of the device 905. For example, the transmitter 915 may transmit information such as packets, user data, control information, or any combination thereof associated with various information channels (e.g., control channels, data channels, information channels related to adaptive feedback methods for subband full duplex systems). In some examples, the transmitter 915 may be co-located with a receiver 910 in a transceiver module. The transmitter 915 may utilize a single antenna or a set of multiple antennas.

The device 905, or various components thereof, may be an example of means for performing various aspects of adaptive feedback methods for subband full duplex systems as described herein. For example, the communications manager 920 may include a configuration manager 925, a control manager 930, an allocation manager 935, a feedback manager 940, or any combination thereof. The communications manager 920 may be an example of aspects of a communications manager 820 as described herein. In some examples, the communications manager 920, or various components thereof, may be configured to perform various operations (e.g., receiving, monitoring, transmitting) using or otherwise in cooperation with the receiver 910, the transmitter 915, or both. For example, the communications manager 920 may receive information from the receiver 910, send information to the transmitter 915, or be integrated in combination with the receiver 910, the transmitter 915, or both to receive information, transmit information, or perform various other operations as described herein.

The communications manager 920 may support wireless communication at a full duplex UE in accordance with examples as disclosed herein. The configuration manager 925 may be configured as or otherwise support a means for identifying a feedback channel configuration that maps a set of multiple subchannels of a sidelink channel to a set of multiple feedback resources of a feedback channel of the sidelink channel. The control manager 930 may be configured as or otherwise support a means for receiving control signaling scheduling the full duplex UE to transmit or receive a first sidelink message in a first subchannel of the set of multiple subchannels. The allocation manager 935 may be configured as or otherwise support a means for assigning a first feedback resource of the set of multiple feedback resources for transmission or reception of feedback for the first sidelink message that differs from a default resource identified by the feedback channel configuration. The feedback manager 940 may be configured as or otherwise support a means for communicating feedback data for the first sidelink message in the first feedback resource of the feedback channel based on the assigning.

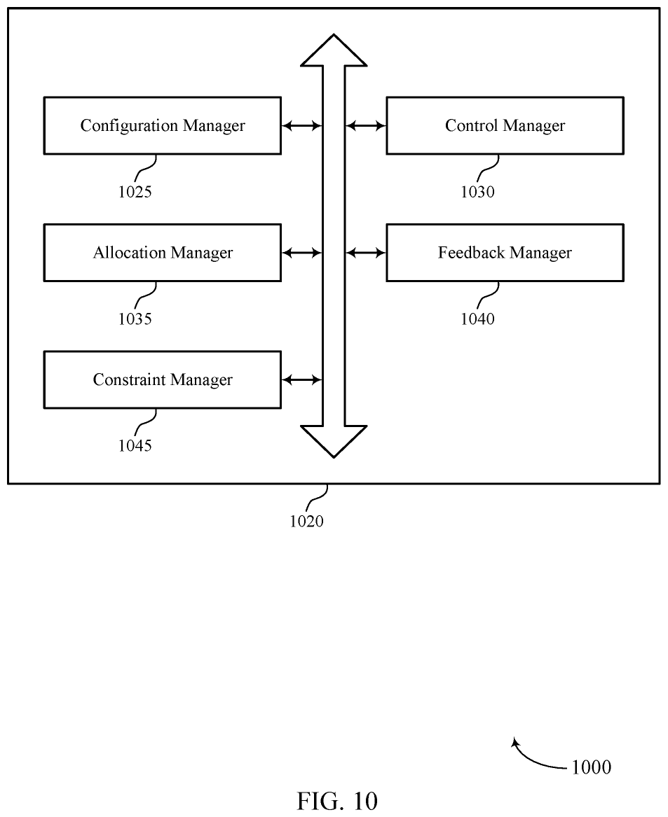

FIG. 10 shows a block diagram 1000 of a communications manager 1020 that supports adaptive feedback methods for subband full duplex systems in accordance with aspects of the present disclosure. The communications manager 1020 may be an example of aspects of a communications manager 820, a communications manager 920, or both, as described herein. The communications manager 1020, or various components thereof, may be an example of means for performing various aspects of adaptive feedback methods for subband full duplex systems as described herein. For example, the communications manager 1020 may include a configuration manager 1025, a control manager 1030, an allocation manager 1035, a feedback manager 1040, a constraint manager 1045, or any combination thereof. Each of these components may communicate, directly or indirectly, with one another (e.g., via one or more buses).

The communications manager 1020 may support wireless communication at a full duplex UE in accordance with examples as disclosed herein. The configuration manager 1025 may be configured as or otherwise support a means for identifying a feedback channel configuration that maps a set of multiple subchannels of a sidelink channel to a set of multiple feedback resources of a feedback channel of the sidelink channel. The control manager 1030 may be configured as or otherwise support a means for receiving control signaling scheduling the full duplex UE to transmit or receive a first sidelink message in a first subchannel of the set of multiple subchannels. The allocation manager 1035 may be configured as or otherwise support a means for assigning a first feedback resource of the set of multiple feedback resources for transmission or reception of feedback for the first sidelink message that differs from a default resource identified by the feedback channel configuration. The feedback manager 1040 may be configured as or otherwise support a means for communicating feedback data for the first sidelink message in the first feedback resource of the feedback channel based on the assigning. In some examples, the feedback channel configuration indicates that the first feedback resource is a guard band.

In some examples, to support communicating the feedback data, the feedback manager 1040 may be configured as or otherwise support a means for receiving the feedback data or transmitting the feedback data.

In some examples, to support identifying, the configuration manager 1025 may be configured as or otherwise support a means for receiving a control message indicating the feedback channel configuration.

In some examples, the feedback manager 1040 may be configured as or otherwise support a means for receiving, via the first subchannel, the first sidelink message and a second sidelink message in different transmission time intervals that each correspond to the first feedback resource. In some examples, the feedback manager 1040 may be configured as or otherwise support a means for transmitting the feedback data for the first sidelink message in the first feedback resource based on a priority of the first sidelink message relative to a priority of the second sidelink message.

In some examples, the control manager 1030 may be configured as or otherwise support a means for receiving second control signaling scheduling the full duplex UE to transmit or receive a second sidelink message in a second subchannel of the set of multiple subchannels.

In some examples, to support communicating, the control manager 1030 may be configured as or otherwise support a means for communicating second feedback data for the second sidelink message on a second feedback resource of the set of multiple feedback resources based on a priority of the second sidelink message relative to a priority of the first sidelink message.

In some examples, to support communicating, the feedback manager 1040 may be configured as or otherwise support a means for transmitting the feedback data for the first sidelink message on a transmit feedback resource and receiving second feedback data for a second sidelink resource on a receive feedback resource having a guard band between the transmit feedback resource and the receive feedback resource, where a first location of the guard band within the set of multiple feedback resources differs from a second location of the guard band indicated in the feedback channel configuration.

In some examples, the allocation manager 1035 may be configured as or otherwise support a means for assigning each feedback resource of the set of multiple feedback resources for transmission or reception of feedback for a respective sidelink message of a set of multiple sidelink messages based on a priority of each sidelink message of the set of multiple sidelink messages.

In some examples, to support assigning the first feedback resource, the allocation manager 1035 may be configured as or otherwise support a means for assigning the first feedback resource for transmission or reception of feedback for the first sidelink message that differs from a second feedback resource indicated in the feedback channel configuration based on a priority of the first sidelink message.

In some examples, to support assigning the first feedback resource, the allocation manager 1035 may be configured as or otherwise support a means for assigning the first feedback resource for transmission or reception of feedback for the first sidelink message that differs from a second feedback resource indicated in the feedback channel configuration based on a priority of feedback transmission of the first sidelink message relative to a priority of feedback reception for a second sidelink message within the first feedback resource.

In some examples, to support assigning the first feedback resource, the allocation manager 1035 may be configured as or otherwise support a means for assigning the first feedback resource for transmission or reception of feedback for the first sidelink message that differs from a second feedback resource indicated in the feedback channel configuration based on a location of a guard band assigned by the full duplex UE within the set of multiple feedback resources or indicated by the feedback channel configuration.

In some examples, to support communicating, the feedback manager 1040 may be configured as or otherwise support a means for communicating the feedback data for the first sidelink message in the first feedback resource of the feedback channel based on using a second feedback resource of the set of multiple feedback resources as a guard band, where the feedback channel configuration indicates the second feedback resource is a transmission feedback resource or a reception feedback resource.

In some examples, to support assigning, the constraint manager 1045 may be configured as or otherwise support a means for assigning the set of multiple feedback resources to increase or maximize a number of transmit feedback resources, a number of receive feedback resources, or both, in the set of multiple feedback resources for a transmission time interval relative to a number of set of multiple feedback resources assigned to be a guard band.

In some examples, to support assigning, the constraint manager 1045 may be configured as or otherwise support a means for assigning the set of multiple feedback resources to increase or maximize a number of transmit feedback resources in the set of multiple feedback resources for a transmission time interval, where a number of feedback resources assigned to be a receive feedback resource in the set of multiple feedback resources satisfies a threshold.

In some examples, to support assigning, the constraint manager 1045 may be configured as or otherwise support a means for assigning the set of multiple feedback resources to increase or maximize a number of receive feedback resources in the set of multiple feedback resources for a transmission time interval, where a number of feedback resources assigned to be a transmit feedback resource in the set of multiple feedback resources satisfies a threshold.

In some examples, to support assigning, the constraint manager 1045 may be configured as or otherwise support a means for determining that an initial assignment of the set of multiple feedback resources does not satisfy one or more constraints. In some examples, to support assigning, the constraint manager 1045 may be configured as or otherwise support a means for switching a transmit feedback resource in the initial assignment to be a receive feedback resource, or switching a receive feedback resource the initial assignment to be a transmit feedback resource based on the determining, or both.

In some examples, to support assigning, the constraint manager 1045 may be configured as or otherwise support a means for determining that an initial assignment of the set of multiple feedback resources does not satisfy one or more constraints. In some examples, to support assigning, the constraint manager 1045 may be configured as or otherwise support a means for changing a second feedback resource in the initial assignment to be a guard band between a transmit feedback resource and a receive feedback resource.

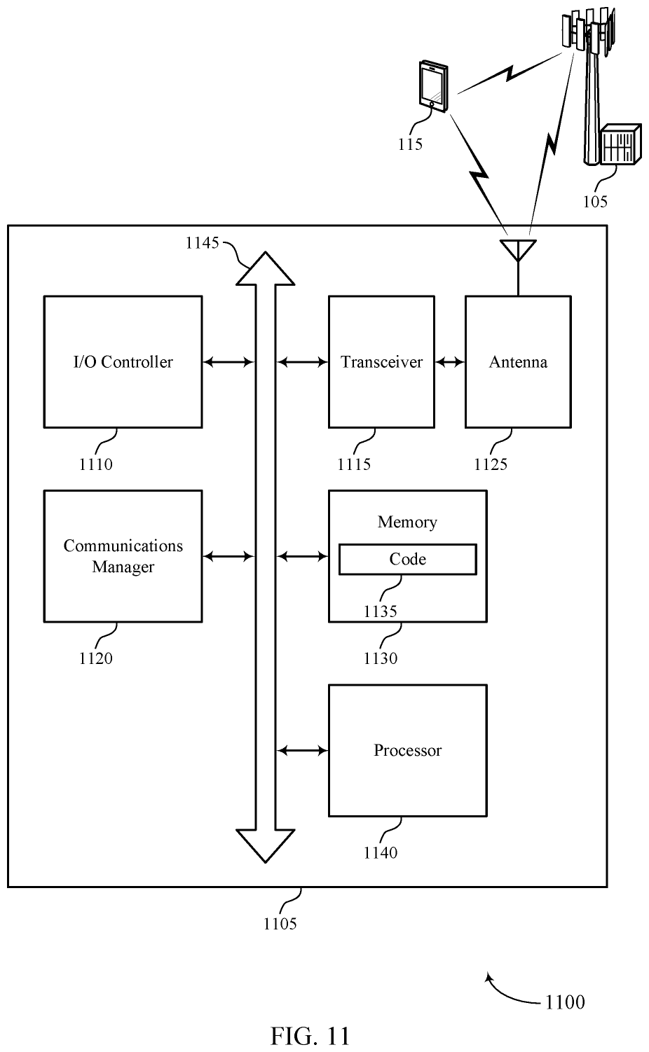

FIG. 11 shows a diagram of a system 1100 including a device 1105 that supports adaptive feedback methods for subband full duplex systems in accordance with aspects of the present disclosure. The device 1105 may be an example of or include the components of a device 805, a device 905, or a UE 115 as described herein. The device 1105 may communicate wirelessly with one or more base stations 105, UEs 115, or any combination thereof. The device 1105 may include components for bi-directional voice and data communications including components for transmitting and receiving communications, such as a communications manager 1120, an input/output (I/O) controller 1110, a transceiver 1115, an antenna 1125, a memory 1130, code 1135, and a processor 1140. These components may be in electronic communication or otherwise coupled (e.g., operatively, communicatively, functionally, electronically, electrically) via one or more buses (e.g., a bus 1145).

The I/O controller 1110 may manage input and output signals for the device 1105. The I/O controller 1110 may also manage peripherals not integrated into the device 1105. In some cases, the I/O controller 1110 may represent a physical connection or port to an external peripheral. In some cases, the I/O controller 1110 may utilize an operating system such as iOS®, ANDROID®, MS-DOS®, MS-WINDOWS®, OS/2®, UNIX®, LINUX®, or another known operating system. Additionally or alternatively, the I/O controller 1110 may represent or interact with a modem, a keyboard, a mouse, a touchscreen, or a similar device. In some cases, the I/O controller 1110 may be implemented as part of a processor, such as the processor 1140. In some cases, a user may interact with the device 1105 via the I/O controller 1110 or via hardware components controlled by the I/O controller 1110.

In some cases, the device 1105 may include a single antenna 1125. However, in some other cases, the device 1105 may have more than one antenna 1125, which may be capable of concurrently transmitting or receiving multiple wireless transmissions. The transceiver 1115 may communicate bi-directionally, via the one or more antennas 1125, wired, or wireless links as described herein. For example, the transceiver 1115 may represent a wireless transceiver and may communicate bi-directionally with another wireless transceiver. The transceiver 1115 may also include a modem to modulate the packets, to provide the modulated packets to one or more antennas 1125 for transmission, and to demodulate packets received from the one or more antennas 1125. The transceiver 1115, or the transceiver 1115 and one or more antennas 1125, may be an example of a transmitter 815, a transmitter 915, a receiver 810, a receiver 910, or any combination thereof or component thereof, as described herein.

The memory 1130 may include random access memory (RAM) and read-only memory (ROM). The memory 1130 may store computer-readable, computer-executable code 1135 including instructions that, when executed by the processor 1140, cause the device 1105 to perform various functions described herein. The code 1135 may be stored in a non-transitory computer-readable medium such as system memory or another type of memory. In some cases, the code 1135 may not be directly executable by the processor 1140 but may cause a computer (e.g., when compiled and executed) to perform functions described herein. In some cases, the memory 1130 may contain, among other things, a basic I/O system (BIOS) which may control basic hardware or software operation such as the interaction with peripheral components or devices.

The processor 1140 may include an intelligent hardware device (e.g., a general-purpose processor, a DSP, a CPU, a microcontroller, an ASIC, an FPGA, a programmable logic device, a discrete gate or transistor logic component, a discrete hardware component, or any combination thereof). In some cases, the processor 1140 may be configured to operate a memory array using a memory controller. In some other cases, a memory controller may be integrated into the processor 1140. The processor 1140 may be configured to execute computer-readable instructions stored in a memory (e.g., the memory 1130) to cause the device 1105 to perform various functions (e.g., functions or tasks supporting adaptive feedback methods for subband full duplex systems). For example, the device 1105 or a component of the device 1105 may include a processor 1140 and memory 1130 coupled to the processor 1140, the processor 1140 and memory 1130 configured to perform various functions described herein.

The communications manager 1120 may support wireless communication at a full duplex UE in accordance with examples as disclosed herein. For example, the communications manager 1120 may be configured as or otherwise support a means for identifying a feedback channel configuration that maps a set of multiple subchannels of a sidelink channel to a set of multiple feedback resources of a feedback channel of the sidelink channel. The communications manager 1120 may be configured as or otherwise support a means for receiving control signaling scheduling the full duplex UE to transmit or receive a first sidelink message in a first subchannel of the set of multiple subchannels. The communications manager 1120 may be configured as or otherwise support a means for assigning a first feedback resource of the set of multiple feedback resources for transmission or reception of feedback for the first sidelink message that differs from a default resource identified by the feedback channel configuration. The communications manager 1120 may be configured as or otherwise support a means for communicating feedback data for the first sidelink message in the first feedback resource of the feedback channel based on the assigning.

By including or configuring the communications manager 1120 in accordance with examples as described herein, the device 1105 may support techniques for adaptive feedback methods for subband full duplex systems. The described techniques may support improvements in system efficiency and quality of service. The described techniques may result in improved communication reliability, reduced latency, improved user experience related to reduced processing, reduced power consumption, more efficient utilization of communication resources, improved coordination between devices, longer battery life, improved utilization of processing capability.

In some examples, the communications manager 1120 may be configured to perform various operations (e.g., receiving, monitoring, transmitting) using or otherwise in cooperation with the transceiver 1115, the one or more antennas 1125, or any combination thereof. Although the communications manager 1120 is illustrated as a separate component, in some examples, one or more functions described with reference to the communications manager 1120 may be supported by or performed by the processor 1140, the memory 1130, the code 1135, or any combination thereof. For example, the code 1135 may include instructions executable by the processor 1140 to cause the device 1105 to perform various aspects of adaptive feedback methods for subband full duplex systems as described herein, or the processor 1140 and the memory 1130 may be otherwise configured to perform or support such operations.

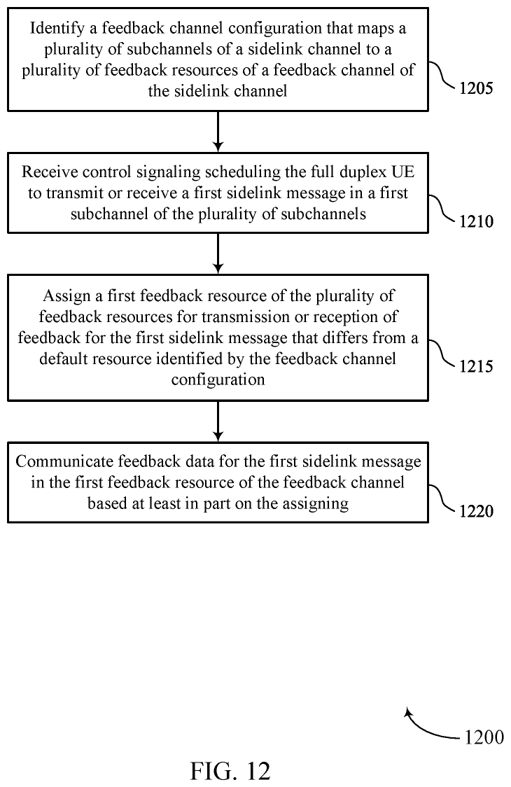

FIG. 12 shows a flowchart illustrating a method 1200 that supports adaptive feedback methods for subband full duplex systems in accordance with aspects of the present disclosure. The operations of the method 1200 may be implemented by a UE or its components as described herein. For example, the operations of the method 1200 may be performed by a UE 115 as described with reference to FIGS. 1 through 11. In some examples, a UE may execute a set of instructions to control the functional elements of the UE to perform the described functions. Additionally or alternatively, the UE may perform aspects of the described functions using special-purpose hardware.

At 1205, the method may include identifying a feedback channel configuration that maps a set of multiple subchannels of a sidelink channel to a set of multiple feedback resources of a feedback channel of the sidelink channel. The operations of 1205 may be performed in accordance with examples as disclosed herein. In some examples, aspects of the operations of 1205 may be performed by a configuration manager 1025 as described with reference to FIG. 10.

At 1210, the method may include receiving control signaling scheduling the full duplex UE to transmit or receive a first sidelink message in a first subchannel of the set of multiple subchannels. The operations of 1210 may be performed in accordance with examples as disclosed herein. In some examples, aspects of the operations of 1210 may be performed by a control manager 1030 as described with reference to FIG. 10.

At 1215, the method may include assigning a first feedback resource of the set of multiple feedback resources for transmission or reception of feedback for the first sidelink message that differs from a default resource identified by the feedback channel configuration. The operations of 1215 may be performed in accordance with examples as disclosed herein. In some examples, aspects of the operations of 1215 may be performed by an allocation manager 1035 as described with reference to FIG. 10.

At 1220, the method may include communicating feedback data for the first sidelink message in the first feedback resource of the feedback channel based on the assigning. The operations of 1220 may be performed in accordance with examples as disclosed herein. In some examples, aspects of the operations of 1220 may be performed by a feedback manager 1040 as described with reference to FIG. 10.

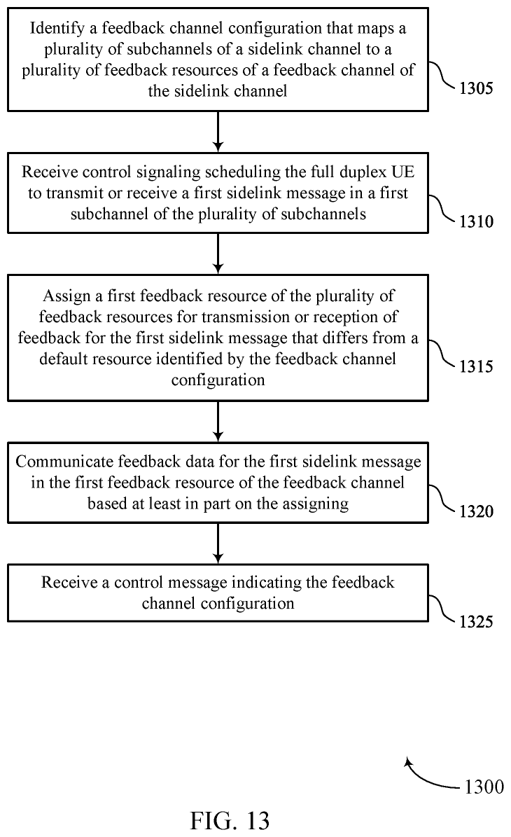

FIG. 13 shows a flowchart illustrating a method 1300 that supports adaptive feedback methods for subband full duplex systems in accordance with aspects of the present disclosure. The operations of the method 1300 may be implemented by a UE or its components as described herein. For example, the operations of the method 1300 may be performed by a UE 115 as described with reference to FIGS. 1 through 11. In some examples, a UE may execute a set of instructions to control the functional elements of the UE to perform the described functions. Additionally or alternatively, the UE may perform aspects of the described functions using special-purpose hardware.

At 1305, the method may include identifying a feedback channel configuration that maps a set of multiple subchannels of a sidelink channel to a set of multiple feedback resources of a feedback channel of the sidelink channel. The operations of 1305 may be performed in accordance with examples as disclosed herein. In some examples, aspects of the operations of 1305 may be performed by a configuration manager 1025 as described with reference to FIG. 10.

At 1310, the method may include receiving control signaling scheduling the full duplex UE to transmit or receive a first sidelink message in a first subchannel of the set of multiple subchannels. The operations of 1310 may be performed in accordance with examples as disclosed herein. In some examples, aspects of the operations of 1310 may be performed by a control manager 1030 as described with reference to FIG. 10.

At 1315, the method may include assigning a first feedback resource of the set of multiple feedback resources for transmission or reception of feedback for the first sidelink message that differs from a default resource identified by the feedback channel configuration. The operations of 1315 may be performed in accordance with examples as disclosed herein. In some examples, aspects of the operations of 1315 may be performed by an allocation manager 1035 as described with reference to FIG. 10.

At 1320, the method may include communicating feedback data for the first sidelink message in the first feedback resource of the feedback channel based on the assigning. The operations of 1320 may be performed in accordance with examples as disclosed herein. In some examples, aspects of the operations of 1320 may be performed by a feedback manager 1040 as described with reference to FIG. 10.

At 1325, the method may include receiving a control message indicating the feedback channel configuration. The operations of 1325 may be performed in accordance with examples as disclosed herein. In some examples, aspects of the operations of 1325 may be performed by a configuration manager 1025 as described with reference to FIG. 10.

The following provides an overview of aspects of the present disclosure:

Aspect 1: A method for wireless communication at a full duplex UE, comprising: identifying a feedback channel configuration that maps a plurality of subchannels of a sidelink channel to a plurality of feedback resources of a feedback channel of the sidelink channel; receiving control signaling scheduling the full duplex UE to transmit or receive a first sidelink message in a first subchannel of the plurality of subchannels; assigning a first feedback resource of the plurality of feedback resources for transmission or reception of feedback for the first sidelink message that differs from a default resource identified by the feedback channel configuration; and communicating feedback data for the first sidelink message in the first feedback resource of the feedback channel based at least in part on the assigning.

Aspect 2: The method of aspect 1, wherein communicating the feedback data comprises: receiving the feedback data or transmitting the feedback data.

Aspect 3: The method of any of aspects 1 through 2, wherein the identifying further comprises: receiving a control message indicating the feedback channel configuration.

Aspect 4: The method of any of aspects 1 through 3, further comprising: receiving, via the first subchannel, the first sidelink message and a second sidelink message in different transmission time intervals that each correspond to the first feedback resource; and transmitting the feedback data for the first sidelink message in the first feedback resource based at least in part on a priority of the first sidelink message relative to a priority of the second sidelink message.

Aspect 5: The method of any of aspects 1 through 4, further comprising: receiving second control signaling scheduling the full duplex UE to transmit or receive a second sidelink message in a second subchannel of the plurality of subchannels.

Aspect 6: The method of aspect 5, wherein the communicating further comprises: communicating second feedback data for the second sidelink message on a second feedback resource of the plurality of feedback resources based at least in part on a priority of the second sidelink message relative to a priority of the first sidelink message.

Aspect 7: The method of any of aspects 1 through 6, wherein the communicating further comprises: transmitting the feedback data for the first sidelink message on a transmit feedback resource and receiving second feedback data for a second sidelink resource on a receive feedback resource having a guard band between the transmit feedback resource and the receive feedback resource, wherein a first location of the guard band within the plurality of feedback resources differs from a second location of the guard band indicated in the feedback channel configuration.

Aspect 8: The method of any of aspects 1 through 7, further comprising: assigning each feedback resource of the plurality of feedback resources for transmission or reception of feedback for a respective sidelink message of a plurality of sidelink messages based at least in part on a priority of each sidelink message of the plurality of sidelink messages.

Aspect 9: The method of any of aspects 1 through 8, wherein assigning the first feedback resource further comprises: assigning the first feedback resource for transmission or reception of feedback for the first sidelink message that differs from a second feedback resource indicated in the feedback channel configuration based at least in part on a priority of the first sidelink message.

Aspect 10: The method of any of aspects 1 through 9, wherein assigning the first feedback resource further comprises: assigning the first feedback resource for transmission or reception of feedback for the first sidelink message that differs from a second feedback resource indicated in the feedback channel configuration based at least in part on a priority of feedback transmission of the first sidelink message relative to a priority of feedback reception for a second sidelink message within the first feedback resource.

Aspect 11: The method of any of aspects 1 through 10, wherein assigning the first feedback resource further comprises: assigning the first feedback resource for transmission or reception of feedback for the first sidelink message that differs from a second feedback resource indicated in the feedback channel configuration based at least in part on a location of a guard band assigned by the full duplex UE within the plurality of feedback resources or indicated by the feedback channel configuration.

Aspect 12: The method of any of aspects 1 through 11, wherein the feedback channel configuration indicates that the first feedback resource is a guard band.

Aspect 13: The method of any of aspects 1 through 12, wherein the communicating further comprises: communicating the feedback data for the first sidelink message in the first feedback resource of the feedback channel based at least in part on using a second feedback resource of the plurality of feedback resources as a guard band, wherein the feedback channel configuration indicates the second feedback resource is a transmission feedback resource or a reception feedback resource.

Aspect 14: The method of any of aspects 1 through 13, wherein the assigning further comprises: assigning the plurality of feedback resources to increase or maximize a number of transmit feedback resources, a number of receive feedback resources, or both, in the plurality of feedback resources for a transmission time interval relative to a number of plurality of feedback resources assigned to be a guard band.

Aspect 15: The method of any of aspects 1 through 14, wherein the assigning further comprises: assigning the plurality of feedback resources to increase or maximize a number of transmit feedback resources in the plurality of feedback resources for a transmission time interval, wherein a number of feedback resources assigned to be a receive feedback resource in the plurality of feedback resources satisfies a threshold.

Aspect 16: The method of any of aspects 1 through 15, wherein the assigning further comprises: assigning the plurality of feedback resources to increase or maximize a number of receive feedback resources in the plurality of feedback resources for a transmission time interval, wherein a number of feedback resources assigned to be a transmit feedback resource in the plurality of feedback resources satisfies a threshold.

Aspect 17: The method of any of aspects 1 through 16, wherein the assigning further comprises: determining that an initial assignment of the plurality of feedback resources does not satisfy one or more constraints; and switching a transmit feedback resource in the initial assignment to be a receive feedback resource, or switching a receive feedback resource the initial assignment to be a transmit feedback resource based at least in part on the determining, or both.

Aspect 18: The method of any of aspects 1 through 17, wherein the assigning further comprises: determining that an initial assignment of the plurality of feedback resources does not satisfy one or more constraints; and changing a second feedback resource in the initial assignment to be a guard band between a transmit feedback resource and a receive feedback resource.

Aspect 19: An apparatus for wireless communication at a full duplex UE, comprising a processor; memory coupled with the processor; and instructions stored in the memory and executable by the processor to cause the apparatus to perform a method of any of aspects 1 through 18.

Aspect 20: An apparatus for wireless communication at a full duplex UE, comprising at least one means for performing a method of any of aspects 1 through 18.

Aspect 21: A non-transitory computer-readable medium storing code for wireless communication at a full duplex UE, the code comprising instructions executable by a processor to perform a method of any of aspects 1 through 18.

It should be noted that the methods described herein describe possible implementations, and that the operations and the steps may be rearranged or otherwise modified and that other implementations are possible. Further, aspects from two or more of the methods may be combined.

Although aspects of an LTE, LTE-A, LTE-A Pro, or NR system may be described for purposes of example, and LTE, LTE-A, LTE-A Pro, or NR terminology may be used in much of the description, the techniques described herein are applicable beyond LTE, LTE-A, LTE-A Pro, or NR networks. For example, the described techniques may be applicable to various other wireless communications systems such as Ultra Mobile Broadband (UMB), Institute of Electrical and Electronics Engineers (IEEE) 802.11 (Wi-Fi), IEEE 802.16 (WiMAX), IEEE 802.20, Flash-OFDM, as well as other systems and radio technologies not explicitly mentioned herein.

Information and signals described herein may be represented using any of a variety of different technologies and techniques. For example, data, instructions, commands, information, signals, bits, symbols, and chips that may be referenced throughout the description may be represented by voltages, currents, electromagnetic waves, magnetic fields or particles, optical fields or particles, or any combination thereof.

The various illustrative blocks and components described in connection with the disclosure herein may be implemented or performed with a general-purpose processor, a DSP, an ASIC, a CPU, an FPGA or other programmable logic device, discrete gate or transistor logic, discrete hardware components, or any combination thereof designed to perform the functions described herein. A general-purpose processor may be a microprocessor, but in the alternative, the processor may be any processor, controller, microcontroller, or state machine. A processor may also be implemented as a combination of computing devices (e.g., a combination of a DSP and a microprocessor, multiple microprocessors, one or more microprocessors in conjunction with a DSP core, or any other such configuration).

The functions described herein may be implemented in hardware, software executed by a processor, firmware, or any combination thereof. If implemented in software executed by a processor, the functions may be stored on or transmitted over as one or more instructions or code on a computer-readable medium. Other examples and implementations are within the scope of the disclosure and appended claims. For example, due to the nature of software, functions described herein may be implemented using software executed by a processor, hardware, firmware, hardwiring, or combinations of any of these. Features implementing functions may also be physically located at various positions, including being distributed such that portions of functions are implemented at different physical locations.

Computer-readable media includes both non-transitory computer storage media and communication media including any medium that facilitates transfer of a computer program from one place to another. A non-transitory storage medium may be any available medium that may be accessed by a general-purpose or special-purpose computer. By way of example, and not limitation, non-transitory computer-readable media may include RAM, ROM, electrically erasable programmable ROM (EEPROM), flash memory, compact disk (CD) ROM or other optical disk storage, magnetic disk storage or other magnetic storage devices, or any other non-transitory medium that may be used to carry or store desired program code means in the form of instructions or data structures and that may be accessed by a general-purpose or special-purpose computer, or a general-purpose or special-purpose processor. Also, any connection is properly termed a computer-readable medium. For example, if the software is transmitted from a website, server, or other remote source using a coaxial cable, fiber optic cable, twisted pair, digital subscriber line (DSL), or wireless technologies such as infrared, radio, and microwave, then the coaxial cable, fiber optic cable, twisted pair, DSL, or wireless technologies such as infrared, radio, and microwave are included in the definition of computer-readable medium. Disk and disc, as used herein, include CD, laser disc, optical disc, digital versatile disc (DVD), floppy disk and Blu-ray disc where disks usually reproduce data magnetically, while discs reproduce data optically with lasers. Combinations of the above are also included within the scope of computer-readable media.

As used herein, including in the claims, “or” as used in a list of items (e.g., a list of items prefaced by a phrase such as “at least one of” or “one or more of”) indicates an inclusive list such that, for example, a list of at least one of A, B, or C means A or B or C or AB or AC or BC or ABC (i.e., A and B and C). Also, as used herein, the phrase “based on” shall not be construed as a reference to a closed set of conditions. For example, an example step that is described as “based on condition A” may be based on both a condition A and a condition B without departing from the scope of the present disclosure. In other words, as used herein, the phrase “based on” shall be construed in the same manner as the phrase “based at least in part on.”

The term “determine” or “determining” encompasses a wide variety of actions and, therefore, “determining” can include calculating, computing, processing, deriving, investigating, looking up (such as via looking up in a table, a database or another data structure), ascertaining and the like. Also, “determining” can include receiving (such as receiving information), accessing (such as accessing data in a memory) and the like. Also, “determining” can include resolving, selecting, choosing, establishing and other such similar actions.

In the appended figures, similar components or features may have the same reference label. Further, various components of the same type may be distinguished by following the reference label by a dash and a second label that distinguishes among the similar components. If just the first reference label is used in the specification, the description is applicable to any one of the similar components having the same first reference label irrespective of the second reference label, or other subsequent reference label.

The description set forth herein, in connection with the appended drawings, describes example configurations and does not represent all the examples that may be implemented or that are within the scope of the claims. The term “example” used herein means “serving as an example, instance, or illustration,” and not “preferred” or “advantageous over other examples.” The detailed description includes specific details for the purpose of providing an understanding of the described techniques. These techniques, however, may be practiced without these specific details. In some instances, known structures and devices are shown in block diagram form in order to avoid obscuring the concepts of the described examples.

The description herein is provided to enable a person having ordinary skill in the art to make or use the disclosure. Various modifications to the disclosure will be apparent to a person having ordinary skill in the art, and the generic principles defined herein may be applied to other variations without departing from the scope of the disclosure. Thus, the disclosure is not limited to the examples and designs described herein but is to be accorded the broadest scope consistent with the principles and novel features disclosed herein.

What is claimed is:

1. A method for wireless communication at a full duplex user equipment (UE), comprising:
identifying a feedback channel configuration that maps a plurality of subchannels of a sidelink channel to a plurality of feedback resources of a feedback channel of the sidelink channel;
receiving control signaling scheduling the full duplex UE to transmit or receive a first sidelink message in a first subchannel of the plurality of subchannels;
assigning a first feedback resource of the plurality of feedback resources for transmission or reception of feedback for the first sidelink message that differs from a default resource identified by the feedback channel configuration; and
communicating feedback data for the first sidelink message in the first feedback resource of the feedback channel based at least in part on the assigning.

2. The method of claim 1, wherein communicating the feedback data comprises:
receiving the feedback data or transmitting the feedback data.

3. The method of claim 1, wherein the identifying further comprises:
receiving a control message indicating the feedback channel configuration.

4. The method of claim 1, further comprising:
receiving, via the first subchannel, the first sidelink message and a second sidelink message in different transmission time intervals that each correspond to the first feedback resource; and
transmitting the feedback data for the first sidelink message in the first feedback resource based at least in part on a priority of the first sidelink message relative to a priority of the second sidelink message.

5. The method of claim 1, further comprising:
receiving second control signaling scheduling the full duplex UE to transmit or receive a second sidelink message in a second subchannel of the plurality of subchannels.

6. The method of claim 5, wherein the communicating further comprises:
communicating second feedback data for the second sidelink message on a second feedback resource of the plurality of feedback resources based at least in part on a priority of the second sidelink message relative to a priority of the first sidelink message.

7. The method of claim 1, wherein the communicating further comprises:
transmitting the feedback data for the first sidelink message on a transmit feedback resource and receiving second feedback data for a second sidelink resource on a receive feedback resource having a guard band between the transmit feedback resource and the receive feedback resource, wherein a first location of the guard band within the plurality of feedback resources differs from a second location of the guard band indicated in the feedback channel configuration.

8. The method of claim 1, further comprising:
assigning each feedback resource of the plurality of feedback resources for transmission or reception of feedback for a respective sidelink message of a plurality of sidelink messages based at least in part on a priority of each sidelink message of the plurality of sidelink messages.

9. The method of claim 1, wherein assigning the first feedback resource further comprises:
assigning the first feedback resource for transmission or reception of feedback for the first sidelink message that differs from a second feedback resource indicated in the feedback channel configuration based at least in part on a priority of the first sidelink message.

10. The method of claim 1, wherein assigning the first feedback resource further comprises:
assigning the first feedback resource for transmission or reception of feedback for the first sidelink message that differs from a second feedback resource indicated in the feedback channel configuration based at least in part on a priority of feedback transmission of the first sidelink message relative to a priority of feedback reception for a second sidelink message within the first feedback resource.

11. The method of claim 1, wherein assigning the first feedback resource further comprises:
assigning the first feedback resource for transmission or reception of feedback for the first sidelink message that differs from a second feedback resource indicated in the feedback channel configuration based at least in part on a location of a guard band assigned by the full duplex UE within the plurality of feedback resources or indicated by the feedback channel configuration.

12. The method of claim 1, wherein the feedback channel configuration indicates that the first feedback resource is a guard band.

13. The method of claim 1, wherein the communicating further comprises:
communicating the feedback data for the first sidelink message in the first feedback resource of the feedback channel based at least in part on using a second feedback resource of the plurality of feedback resources as a guard band, wherein the feedback channel configuration indicates the second feedback resource is a transmission feedback resource or a reception feedback resource.

14. The method of claim 1, wherein the assigning further comprises:
assigning the plurality of feedback resources to increase or maximize a number of transmit feedback resources, a number of receive feedback resources, or both, in the plurality of feedback resources for a transmission time interval relative to a number of plurality of feedback resources assigned to be a guard band.

15. The method of claim 1, wherein the assigning further comprises:
assigning the plurality of feedback resources to increase or maximize a number of transmit feedback resources in the plurality of feedback resources for a transmission time interval, wherein a number of feedback resources assigned to be a receive feedback resource in the plurality of feedback resources satisfies a threshold.

16. The method of claim 1, wherein the assigning further comprises:
assigning the plurality of feedback resources to increase or maximize a number of receive feedback resources in the plurality of feedback resources for a transmission time interval, wherein a number of feedback resources assigned to be a transmit feedback resource in the plurality of feedback resources satisfies a threshold.

17. The method of claim 1, wherein the assigning further comprises:
determining that an initial assignment of the plurality of feedback resources does not satisfy one or more constraints; and
switching a transmit feedback resource in the initial assignment to be a receive feedback resource, or switching a receive feedback resource the initial assignment to be a transmit feedback resource based at least in part on the determining, or both.

18. The method of claim 1, wherein the assigning further comprises:
determining that an initial assignment of the plurality of feedback resources does not satisfy one or more constraints; and
changing a second feedback resource in the initial assignment to be a guard band between a transmit feedback resource and a receive feedback resource.

19. An apparatus for wireless communication at a full duplex user equipment (UE), comprising:
a processor;
memory coupled with the processor; and
instructions stored in the memory and executable by the processor to cause the apparatus to:
identify a feedback channel configuration that maps a plurality of subchannels of a sidelink channel to a plurality of feedback resources of a feedback channel of the sidelink channel;
receive control signaling scheduling the full duplex UE to transmit or receive a first sidelink message in a first subchannel of the plurality of subchannels;
assign a first feedback resource of the plurality of feedback resources for transmission or reception of feedback for the first sidelink message that differs from a default resource identified by the feedback channel configuration; and
communicate feedback data for the first sidelink message in the first feedback resource of the feedback channel based at least in part on the assigning.

20. The apparatus of claim 19, further comprising a receiver, wherein the instructions to communicate the feedback data are executable by the processor to cause the apparatus to:
receive, via the receiver, the feedback data or transmitting the feedback data.

21. The apparatus of claim 19, further comprising a receiver, wherein the instructions to identify are further executable by the processor to cause the apparatus to:
receive, via the receiver, a control message indicating the feedback channel configuration.

22. The apparatus of claim 19, wherein the instructions are further executable by the processor to cause the apparatus to:
receive, via the first subchannel, the first sidelink message and a second sidelink message in different transmission time intervals that each correspond to the first feedback resource; and
transmit the feedback data for the first sidelink message in the first feedback resource based at least in part on a priority of the first sidelink message relative to a priority of the second sidelink message.

23. The apparatus of claim 19, wherein the instructions are further executable by the processor to cause the apparatus to:
receive second control signaling scheduling the full duplex UE to transmit or receive a second sidelink message in a second subchannel of the plurality of subchannels.

24. The apparatus of claim 23, wherein the instructions to communicate are further executable by the processor to cause the apparatus to:
communicate second feedback data for the second sidelink message on a second feedback resource of the plurality of feedback resources based at least in part on a priority of the second sidelink message relative to a priority of the first sidelink message.

25. The apparatus of claim 19, wherein the instructions to communicate are further executable by the processor to cause the apparatus to:
transmit the feedback data for the first sidelink message on a transmit feedback resource and receiving second feedback data for a second sidelink resource on a receive feedback resource having a guard band between the transmit feedback resource and the receive feedback resource, wherein a first location of the guard band within the plurality of feedback resources differs from a second location of the guard band indicated in the feedback channel configuration.

26. The apparatus of claim 19, wherein the instructions are further executable by the processor to cause the apparatus to:
assign each feedback resource of the plurality of feedback resources for transmission or reception of feedback for a respective sidelink message of a plurality of sidelink messages based at least in part on a priority of each sidelink message of the plurality of sidelink messages.

27. The apparatus of claim 19, wherein the instructions to assign the first feedback resource are further executable by the processor to cause the apparatus to:
assign the first feedback resource for transmission or reception of feedback for the first sidelink message that differs from a second feedback resource indicated in the feedback channel configuration based at least in part on a priority of the first sidelink message.

28. The apparatus of claim 19, wherein the instructions to assign the first feedback resource are further executable by the processor to cause the apparatus to:
assign the first feedback resource for transmission or reception of feedback for the first sidelink message that differs from a second feedback resource indicated in the feedback channel configuration based at least in part on a priority of feedback transmission of the first sidelink message relative to a priority of feedback reception for a second sidelink message within the first feedback resource.

29. An apparatus for wireless communication at a full duplex user equipment (UE), comprising:
means for identifying a feedback channel configuration that maps a plurality of subchannels of a sidelink channel to a plurality of feedback resources of a feedback channel of the sidelink channel;
means for receiving control signaling scheduling the full duplex UE to transmit or receive a first sidelink message in a first subchannel of the plurality of subchannels;
means for assigning a first feedback resource of the plurality of feedback resources for transmission or reception of feedback for the first sidelink message that differs from a default resource identified by the feedback channel configuration; and
means for communicating feedback data for the first sidelink message in the first feedback resource of the feedback channel based at least in part on the assigning.

30. A non-transitory computer-readable medium storing code for wireless communication at a full duplex user equipment (UE), the code comprising instructions executable by a processor to:
identify a feedback channel configuration that maps a plurality of subchannels of a sidelink channel to a plurality of feedback resources of a feedback channel of the sidelink channel;
receive control signaling scheduling the full duplex UE to transmit or receive a first sidelink message in a first subchannel of the plurality of subchannels;
assign a first feedback resource of the plurality of feedback resources for transmission or reception of feedback for the first sidelink message that differs from a default resource identified by the feedback channel configuration; and
communicate feedback data for the first sidelink message in the first feedback resource of the feedback channel based at least in part on the assigning.
